(19) United States
(12) Patent Application Publication
(10) Pub. No.: US 2006/0059024 A1
(43) Pub. Date: Mar. 16, 2006

(54) Advanced travel management system

(75) Inventors: Maurice Bailey, Los Gatos, CA (US); Roman Smolgovsky, Foster City, CA (US)

Correspondence Address: SQUIRE, SANDERS & DEMPSEY L.L.P, 600 HANSEN WAY, PALO ALTO, CA, 94304-1043, US

(73) Assignee: FLYTECOMM, INC., Mountain View, CA (US)

(21) Appl. No.: 10/533,242

(22) PCT Filed: Nov. 7, 2003
(86) PCT No.: PCT/US03/35556

§ 371 Date: Apr. 29, 2005

Related U.S. Application Data
(60) Provisional application No. 60/424,830, filed on Nov. 7, 2002.
(60) Provisional application No. 60/472,943, filed on May 23, 2003.

(51) Int. Cl. G06Q 10/00; G01C 21/34

(52) U.S. Cl. 705/5; 705/6

(57) ABSTRACT

Computer-based systems are described that afford the ability to associate a travel related object with a travel relate event and/or other travel related object. The system enables the acquisition, integration and management of data supplied by multiple, heterogeneous sources; single and multi-level exception handling, error correction, data enhancement, and data prediction; and fine-grained control of the distribution, access and display of this data to multiple users and non-users of the system. The system supports both consumer-facing constructs (e.g., applications that allow passengers to track flight and flight-specific information), and supra-management system-facing constructs (e.g., advancements, enhancements and augmentations of and for the management of the National Airspace System or airport ground traffic systems).

### TECHNICAL FIELD

The present invention relates to the field of travel management. More specifically, the inventive system relates to the management, distribution and display of data from multiple heterogeneous sources towards the completion of an overall end product or service. These end products or services can be provided to consumers (passengers), passenger travel managers, passenger travel systems, package logistics systems, vehicle tracking systems, vehicle traffic management systems, and the like.

### BACKGROUND

Multiple discrete travel management systems have been developed and deployed over the years, with each system singularly focused on providing limited information on a particular class of activities to a restricted group of users. In general these travel management systems fall within the following three broad classes:
1) Air traffic management systems—which allow for the tracking of flights through the National Airspace System (NAS) and at airports, with the pool of users restricted air traffic controllers, tower controllers, pilots, and related personnel. The United States airspace is divided into 21 zones (centers), and each zone is divided into sectors. Within each zone are portions of airspace, about 50 miles (80.5 km) in diameter, called TRACON (Terminal Radar Approach CONtrol) airspaces. Within each TRACON airspace are a number of airports, each of which has its own airspace with a 5-mile (8-km) radius. Thus air traffic management systems encompass such things as:
   Air Traffic Control System Command Center (ATCSCC)—The ATCSCC oversees all air traffic control. It also manages air traffic control within centers where there are problems (bad weather, traffic overloads, inoperative runways).
   Air route traffic control centers (ARTCC)—There is one ARTCC for each center. Each ARTCC manages traffic within all sectors of its center except for TRACON airspace and local-airport airspace.
   Terminal radar approach control—TRACON handles departing and approaching aircraft within its space.
   Air traffic control tower (ATCT)—An ATCT is located at every airport that has regularly scheduled flights. Towers handle all takeoff, landing, and ground traffic.
   Flight service station (FSS)—The FSS provides information (weather, route, terrain, flight plan) for private pilots flying into and out of small airports and rural areas. It assists pilots in emergencies and coordinates search-and-rescue operations for missing or overdue aircraft.
2) Passenger logistics systems—typically, systems which afford the ability to track information about particular flights based on the people who are to be boarding those flights, with the pool of users restricted to passengers, travel agents/agencies, airlines, etc. Information is usually limited to such things as planned/actual arrival and departure times, gate changes, etc. Example passenger logistic systems include:
   Galileo, Sabre, and other airline operated logistics systems—which present some data to the airlines, and a more limited set of information to passengers.
   Travelocity, Orbitz, and other third party travel planning systems—which attempt to send notifications to passengers regarding flight status and operational changes.
3) Ground logistic systems—which report on the position and/or movement of objects in a “non-airplane” environment, typically presented with some static background map-like presentation, with the data directed to system owners or discrete system users. Example systems in this class include:
   Hertz “Never Lost”—an in-car system which affords a driver a line-map of his current location, and a pointer (representing the car and its direction), with logic to given audio and visual instructions for driving directions
   UPS, FedEx package tracking system—online (and offline) systems which update a text-based list of a package's last known location.
   Nextbus and other vehicle tracking systems—which notify passengers waiting for public transit vehicles of the status of the vehicles, including the arrival times of vehicles at stops.
   US Navy's NAVTAG system—which allows for the tracking of naval ships and other vessels for use in tactical war gaming simulation and analysis.
   US EPA's endangered species lists animal tracking program—which provides some real-time and some batch data on the movement of certain animals tagged with radio receivers and/or GPS transceivers.

Although each of the systems described above has some usefulness to its given population of users, each contains certain limitations which are fundamental to their design and implementation, limitations which restrict their ability to offer more useful and usable data to both end users and system owners. More pointedly, these system fail to allow for the ability to associate a travel related object with more than a limited set of travel related events or other travel related objects, especially where the data pertinent to such events or other objects requires data feeds from external systems.

Thus, there is a need in the art for an advanced travel management system which can overcome the limitations of current travel management systems of all types by allowing for the acquisition, integration and management of data supplied by multiple, heterogeneous sources; single and multi-level exception handling, error correction, data enhancement, and data prediction; and fine-grained control of the distribution, access and display of this data to multiple users and non-users of the system as well as to system owners. This new invention herein detailed is mutually advantageous to individuals, corporations, and institutions: it actually increases an organizations' benefits from automation, including improved security, while affording individuals increased knowledge of travel related events that might impact their individual objectives. Its more advanced techniques offer not only wider use at reduced cost, but also greater consumer convenience.

### SUMMARY

The invention comprises several general aspects. Each of those can if desired be combined with additional features, including features disclosed and/or not disclosed herein, the resultant combinations representing more detailed optional embodiments of these aspects.

According to a first aspect of this invention, an advanced travel management system has been provided which comprises a computer system having at least one data processor, at least one data storage device, and at least one communications device through which the computer system can communicate with at least one entity that can connect with the computer system. Stored in the computer system on at least one data storage device is travel management software for storing and managing data associating at least one object with at least one event, accessible at least in part via at least one communications device. The system further comprises data and/or code through which data from at least one data source is collected, processed by at least one processor, optionally loaded into at least one storage system, and distributed via at least one distribution point, or optionally, aggregated in an aggregation point and then distributed, wherein a user of the travel management system can access travel information through at least one access device.

The various additional features included in the various aspects and embodiments described below, even if described as embodiments of a particular type of system, represent options that may be applied singly or in any operable group to any type, combination, and/or enhanced version of travel management system, such as, but not limited to, passenger travel information management systems, travel situation management systems, passenger reservation systems, passenger tracking systems, aircraft routing systems (e.g., en route management systems, TRACON), and others.

In an embodiment pertaining to the advanced travel management system, the system comprises data and/or code for performing at least one of the steps of activating, authenticating, creating, deactivating, destroying, evaluating, generating, implementing, maintaining, modifying, processing, registering, and/or otherwise manipulating the data. In yet another of these embodiments, said at least one data processor may if desired be configured to accept one or more commands to perform these functions only if said command(s) is/are received in conjunction with a PIN(s), password(s) or other authenticating token(s) signifying an entity/entities owning or having a right to control said data and/or said system.

In certain embodiments the advanced travel management system may encrypt all or at least a portion of the data and/or code within the system. In other forms of the foregoing embodiment, the advanced travel management system may encrypt all or at least a portion of the data and/or code collected from at least one data source, processed by at least one processor, loaded into at least one storage system, distributed via at least one distribution point, aggregated in at least one aggregation point, and/or accessed through at least one access device. In still further forms of the foregoing embodiments said data and/or code may be stored, processed and/or communicated without requiring that said data and/or code be decrypted.

In one embodiment of the foregoing general aspect, the travel management system may comprise a plurality of computer systems. In another embodiment the travel management software's modules may be located on different computer systems. In yet another embodiment the travel management software modules may be operated independently of one another.

In certain embodiments the collection of data may be scheduled, dynamic, static, or some combination of scheduled, dynamic and/or static. In certain other embodiments, the collection of data may occur in real time, in near real time, in batch or in some combination of real time, in near real time, and/or batch.

In some embodiments there are a plurality of data sources. In other embodiments, the data sources are heterogeneous. In yet other embodiments, the data sources are supplied by and/or controlled by different entities.

In particular embodiments, the data: may be streamed and/or pulled; may be textual, binary, graphical, or some combination of textual, binary, and/or graphical; may be formatted, unformatted, or some combination of formatted and/or unformatted data; may be complete, incomplete, or partially complete; and may be current, aged, partially aged, or some combination of current, aged, and/or partially aged; and/or may contain at least one inconsistency, or may contain a plurality of inconsistencies.

In one embodiment the data may be contradictory. In certain forms of this embodiment, the contradictory data may come from: a single data source; multiple data sources; different streams from a single data source; and/or different streams from a plurality of data sources. In another form of this embodiment, the contradictory data may be transmitted at different times from a data source(s) and/or at different times within a data stream(s).

In another embodiment the data may contain control codes. In one form of this embodiment the control codes may determine and/or constrain how the data should be parsed. In other forms the control codes may be HTML codes, XML codes, and/or use-specific extensions to XML (e.g., business XML). In yet other forms of this embodiment, the control codes are usable for allowing or denying a user access to the system, to a particular module(s) within the system, to at least a portion of the system, to an access device(s), to a particular class of access device(s), to certain of the data, and/or to a particular class of data. In still other forms the control codes determine a users permission level within the system. In other forms the control codes determine how the data is processed, loaded, stored, distributed, aggregated, accessed, and/or displayed.

In yet another embodiment the processing of the data may take place in real time, in near real time, and/or in batch. In still other embodiments the processing may include the transformation of the data from a first type to at least one other type different from said first type or to a plurality of other types. In certain other embodiments the advanced travel management system may allow for the activating, authenticating, creating, deactivating, destroying, evaluating, generating, implementing, maintaining, modifying, processing, registering, and/or otherwise manipulating of at least one control code. In yet another of these embodiments, said at least one data processor may if desired be configured to accept at least one command to perform these functions only if said command(s) is/are received in conjunction with a PIN(s), password(s) or other authenticating token(s) signifying an entity/entities owning or having a right to control said data or said system.

In an embodiment pertaining to the advanced travel management system, the system comprises data and/or code for performing at least one of the steps of activating, authenticating, creating, deactivating, destroying, evaluating, generating, implementing, maintaining, modifying, processing, registering, and/or otherwise manipulating the data. In yet another of these embodiments, said at least one data processor may if desired be configured to accept at least one command to perform these functions only if said command(s) is/are received in conjunction with a PIN(s), password(s) or other authenticating token(s) signifying an entity/entities owning or having a right to control said data or said system.

In some embodiments of the advanced travel management system, the system's data and/or code may perform exception checking and/or error correction on the data or at least a portion of the data. In certain forms of the preceding embodiments, the exception checking and/or error correction can be performed on the data collected, processed, stored, distributed, aggregated, and/or accessed. In other embodiments of the advanced travel management system, the system's data and/or code may predict the validity of, the veracity of, the type of, and/or the control codes contained within, the data and/or within at least a portion of the data. In certain forms of the preceding embodiments the prediction may be predicated on data planned to be, currently being, and/or already having been collected, processed, stored, distributed, aggregated, and/or accessed.

In certain other forms of the preceding embodiments, the exception checking, error correction, and/or prediction performed may affect feedback on the collection, transmission, processing, storage, distribution, aggregation, accessing and/or displaying of said data.

In some embodiments of the advanced travel management system, a distribution point(s) and/or an aggregation point(s) may receive data from at least one data store or source internal to the system and/or at least one data store or source external to the system.

In particular embodiments at least one communications channel may comprise email systems, web browser based systems, short message systems, instant message systems, voicemail systems, facsimile systems, peer-to-peer networking systems, and/or chat room systems, or some combination of email systems, web browser based systems, short message systems, instant message systems, voicemail systems, facsimile systems, peer-to-peer networking systems, and/or chat room systems.

In certain other embodiments at least one communications device may comprise a computer, an electronic wallet, a cellular phone, a non-cellular phone, a personal digital assistant, a pager, a voice response unit, an automated teller machine, a point of sales terminal, a computerized kiosk, and/or a device capable of representing, displaying, and/or interacting with the information contained within a web page.

In one embodiment of the advance travel management system at least one communications channel and/or at least one communications device may be changed from one type to some other type(s) during at least one communications session, independent of change(s) to the other.

In certain embodiments at least one communications session may be conducted across multiple communications channels and/or multiple communications devices simultaneously.

In other embodiments the outbound and inbound portions of at least one communications session may be conducted across different communications channels and/or different communications devices.

In other embodiments the advanced travel management system may comprise data and/or code for performing, at least in part, at least one of the functions of activating, authenticating, creating, deactivating, destroying, evaluating, generating, implementing, maintaining, modifying, processing, registering, and/or otherwise manipulating: at least one alert; at least one agent; and/or at least one trigger. In certain forms of the foregoing embodiments, the advanced travel management system data processor(s) may, if desired, be configured to accept at least one command to perform these functions only if the command(s) is/are received in conjunction with a PIN(s), password(s) or other authenticating token(s) signifying an entity/entities owning or having a right to control, respectively, the alert(s), the agent(s), and/or the trigger(s).

In one embodiment of the system, data can be displayed in layers. In certain forms of this embodiment, at least one other layer can be added, manipulated, and/or deleted to a first layer or to a plurality of layers without requiring that the application generating the layered data be refreshed. In certain other forms of this embodiment, the layered data may be associated with at least one object or event, and in particular, the objects may consist of weather data, airplane data, geographic data, and/or passenger data.

The following discussion of advantages is not intended to limit the scope of the invention, nor to suggest that every form of the invention will have all of the following advantages. As will be seen from the remainder of this disclosure, the present invention provides a variety of features. These can be used in different combinations. The different combinations are referred to as embodiments. Most embodiments will not include all of the disclosed features. Some simple embodiments can include a very limited selection of these features. Those embodiments may have only one or a few of the advantages described below. Other preferred embodiments will combine more of these features, and will reflect more of the following advantages. Particularly preferred embodiments, that incorporate many of these features, will have most if not all of these advantages. Moreover, additional advantages, not disclosed herein, that are inherent in certain embodiments of the invention, will become apparent to those who practice or carefully consider the invention.

The foregoing and other objects of the invention are achieved by the apparatus and methods described herein which overcome problems inherent in traditional travel management systems and provide a system having the ability to gather data from multiple sources, even from sources not within the system or owned by the system, and after processing, present this information to a wide range of users. The systems ability to acquire, integrate and manage these disparate data sets includes provisions for customizable single and multi-level exception handling, error correction, data enhancement, and data prediction, along with the ability to offer fine-grained control over the distribution, access and display of the end product.

One of the more pronounced advantages of the advanced travel management system is the fundamental capability afforded through the architecture of the system, that is, the elimination of the traditional client-server model for generating, processing and displaying data in favor of a web-services model where the data, the processing (including all feedback control mechanisms), the distribution, and the display are discrete services accessible via any device which can connect in some fashion to the network.

Another advantage of the systems and methods included herein is the ability to discretely control multiple elements of a data display regardless of display device particulars. Examples of these abilities include, but are not limited to:
the ability to define layers within a data display, and to associate discrete objects and class of objects with said layers, wherein the layers, and the objects so associated with each layer, can be user-defined or system defined,
the ability to turn layers off or on at will, without impacting the display capability of other layers and non-associated objects, and without requiring that the device be refreshed,
the ability to split a display into multiple independent areas, with each area capable of presenting data of different types, and each area capable of being updated and/or refreshed independently without impacting any other area, all the while being able to create and maintain links between similar objects represented in each area,
the ability to create multiple versions of the same display, and to enact different filters and display parameters on each version independently, in real-time, with updates and changes to each display being unique to each particular version.

When compared with other travel management systems, the advanced travel management system additionally offers several new and important advantages with respect to access to information through various communications channels and the modalities and devices through which communications can be accessed.
permit the use of a wide array of communications channel(s), freeing users from the shackles of the single channel access methods of more primitive assets management systems.
offer true modality independence. Access to communications channels no longer depends upon the type of communications device(s) used or the underlying physics/mechanics of its means of contact. As such, an advanced travel management system supports a wide array of potential communications devices through which a command(s), a notification(s), an alert(s)and a status(es) information query can be initiated, received and/or accessed.
allow both communications channels and/or communications devices to be changed during a communications session(s), and further allows for both or either to be changed independently of changes to the other, without requiring the termination of the existing communications session(s).
support the simultaneous broadcast of communications sessions to multiple communications channels, and multiple communications devices per channel.
provide for both batch and real-time communications sessions, unlike other systems of record, and allows for messages to be queued and/or buffered for action and/or analysis at a later date.
offer users added security through the use of encryption on the stored, processed and/or communicated data and commands.
provide for the creation, use, and incorporation of attributes and constraints, including but not limited to user-defined, user-selected, and user-determined attributes and constraints, which can be used to further control access to, and maintenance and manipulation of communications sessions, communications channels, communications devices, and/or messages.
allow for the incorporation of agents, alerts and triggers that provide still further control over end-user/system interactions.

### BRIEF DESCRIPTION OF THE DRAWINGS

The invention will be described in detail with reference to the accompanying drawings. Each of the figures is a schematic diagram more fully described below.

FIG. 1 shows an overview of a simple Travel Management System (ATMS), which incorporates at least one data source, at least one processor, at least one storage system, at least one distribution point, at least one access device, and at least one user, wherein data is collected from the data source(s), processed by the processor(s), loaded into the storage system(s), transmitted to the distribution point(s), and accessed via the access device(s), wherein said access device(s) is/are accessed by a user(s).

FIG. 2 shows a portion of an ATMS in which multiple data sources are configured to transmit data to multiple data processors. In particular, FIG. 2 details that a data source may be internal or external to the ATMS, and may transmit data to multiple processors; and a processor may receive data from internal, external, or some combination of internal and external data sources.

FIG. 3 shows a portion of an ATMS in which multiple processors are configured to transmit data to multiple storage systems. In particular, FIG. 3 details that a processor may transmit data to internal, external or some combination of internal and external storage systems; and a storage system may receive data from multiple processors.

FIG. 4 shows a portion of an ATMS in which multiple storage systems are configured to transmit data to multiple distribution points. In particular, FIG. 4 details that a storage system may transmit data to internal, external or some combination of internal and external distribution points; and a distribution point may receive data from internal, external, or some combination of internal and external data sources.

FIG. 5 shows a portion of an ATMS in which multiple distribution points are configured to transmit data to multiple access devices. Additionally, the system may afford for the incorporation of multiple aggregations points which may receive data from multiple distributions points, aggregate the data, and transmit the data to multiple access devices. In particular, FIG. 5 details that a distribution point may transmit data to an internal, external or some combination of internal and external access devices and/or aggregation points; an aggregation point may receive data from internal, external of some combination of internal and external distribution points, aggregation points, data sources, and/or storage systems, and may transmit data to internal, external of some combination of internal and external aggregation points and/or access devices; and an access device may receive data from internal, external of some combination of internal and external distribution points, aggregation points, data sources, and/or storage systems.

FIG. 6 shows a portion of an ATMS in which multiple access devices are configured to transmit and/or display data to users both internal and external to the system. In particular, FIG. 6 details that a single access device may transmit and/or display data to internal, external or some combination of internal and external users; and that a user may receive data from internal, external of some combination of internal and external access devices. Further, FIG. 6 details that control codes may be used to restrict and/or grant access to some users to certain access devices or to at least a portion of the data accessible from these access devices.

FIG. 7 details the use of a feedback control system, comprising an exception handler, a prediction engine and a data enhancer to provide feedback to a subsystem in communications with some other subsystem. In this instance, the feedback is provided to the processor while it is receiving data from a data source.

FIG. 8 details a complex travel management system showing multiple feedback control systems interacting with various modules of the travel management system.

FIG. 9 shows some of the potential access devices capable of interacting with the ATMS.

FIG. 10 details the connections of these devices to a network wherein said network enable communications to these devices over both wired and wireless methods.

FIG. 11—Shows access devices receiving data/communicating with the ATMS and external systems. The ATMS received data, and information via internal and external stimuli via agents, alerts and triggers, and in response, sends and receives communications to its users and to external systems.

FIG. 12—shows a computer system with six modular software subsystems including modules necessary to support functionality for communications, transaction coordination, user interaction, cryptographic processing, records management, and application logic. For each subsystem, commercially available protocols and/or products are listed, any of which may be used to implement the functionality of that module. The critical components of the computer hardware are also listed.

FIG. 13—shows a single computer configuration of an ATMS with hardware and software subsystems wherein the data storage is internal to the computer.

FIG. 14—shows a single computer configuration of an ATMS with hardware and software subsystems wherein the data storage is both internal and external to the computer.

FIG. 15—shows a multiple computer configuration of a system with hardware and software subsystems wherein each computer has its own internal data storage and copies of any or all of the software subsystems. Shared data is stored on a common set of external data storage, typical of a fault-tolerant, clustered configuration.

FIG. 16 shows a multiple computer configuration wherein selected software subsystems are distributed on a network, but acting in a coordinated fashion.

FIG. 17 shows three sample hardware specifications for typical configurations of a repository computer system identifying a small, large, and high availability configuration.

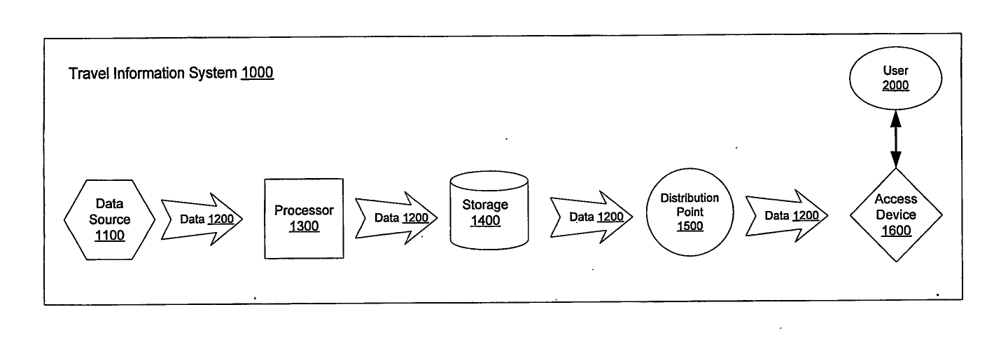

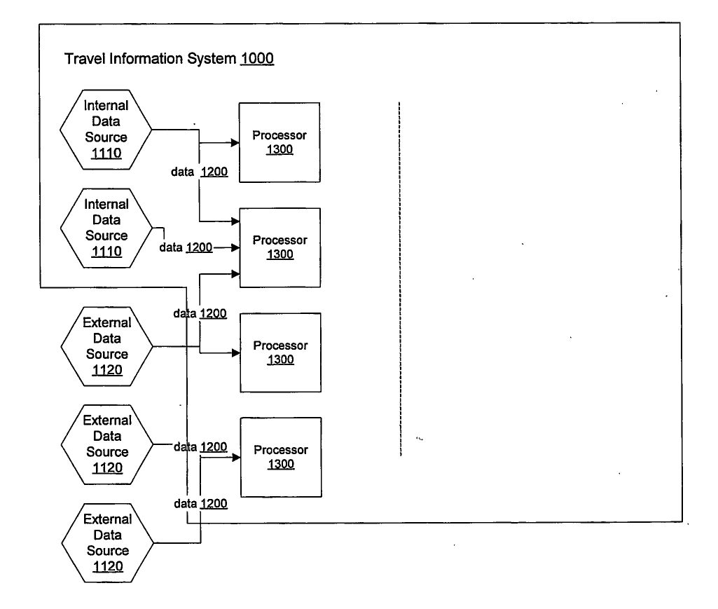

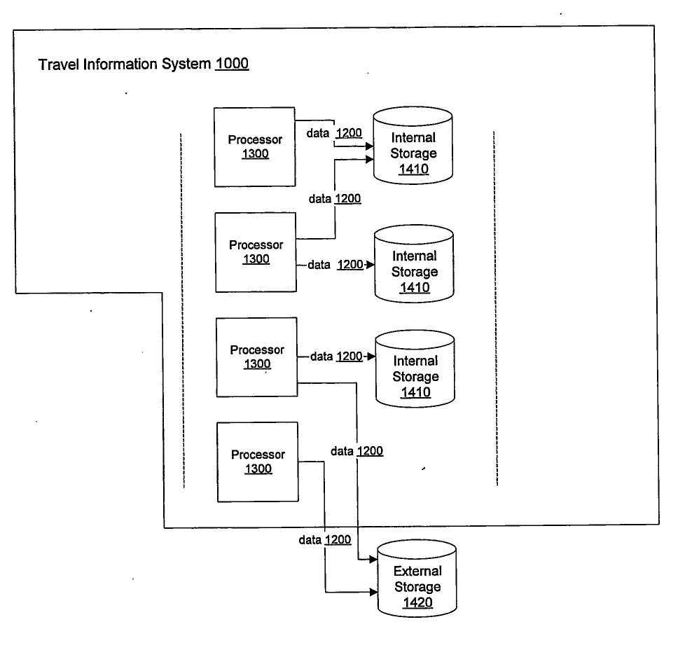

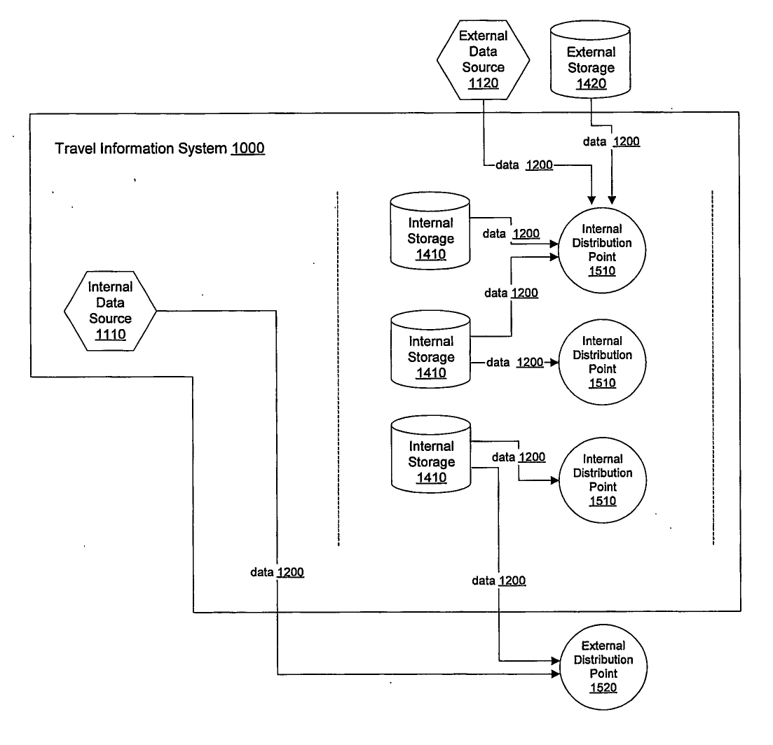

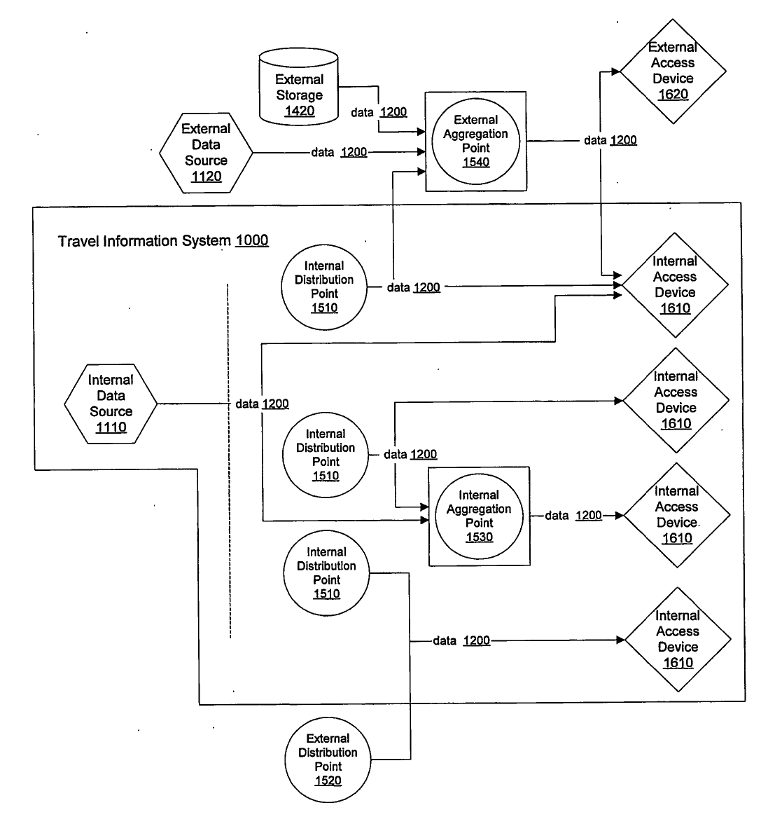

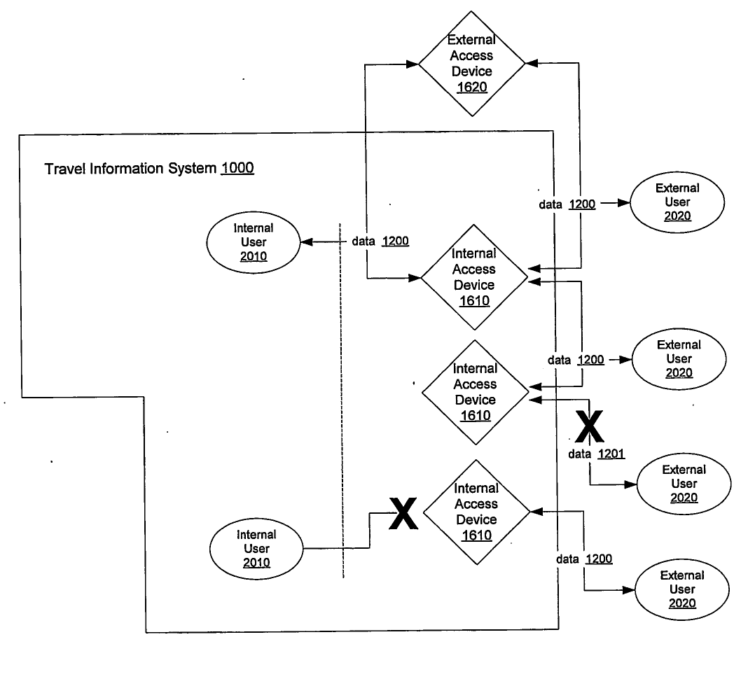

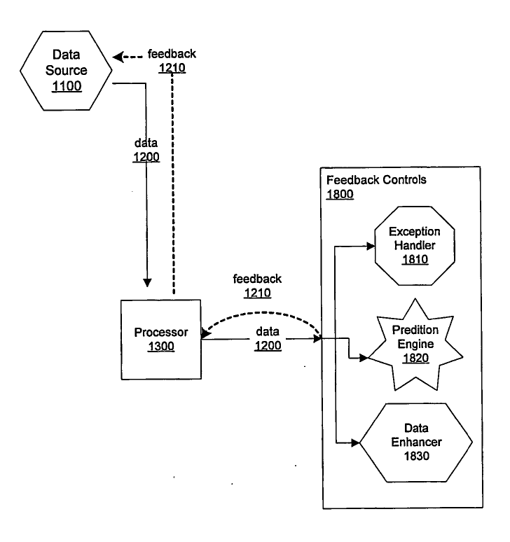

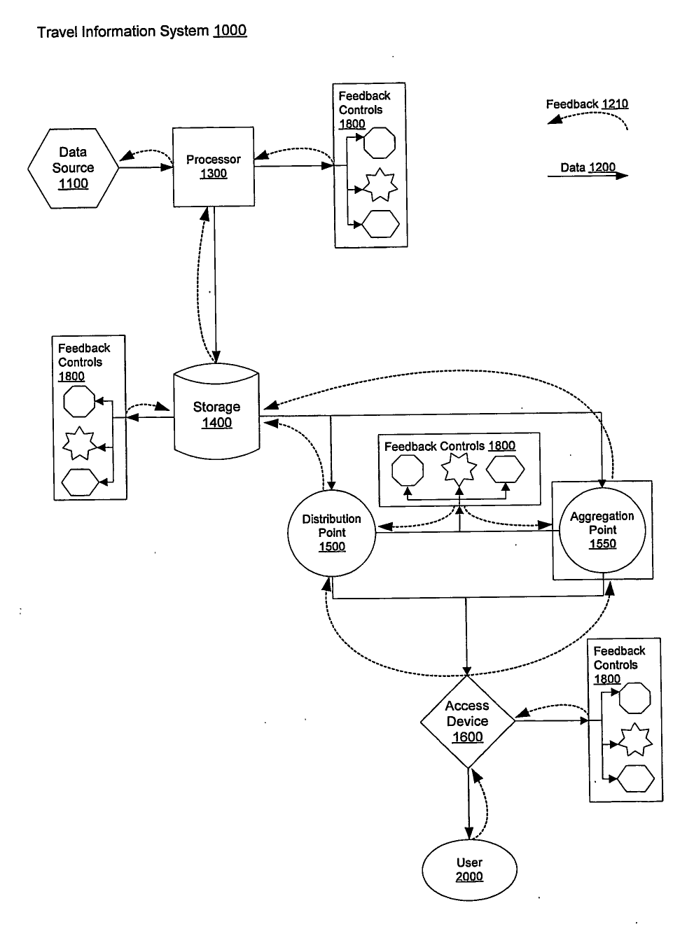

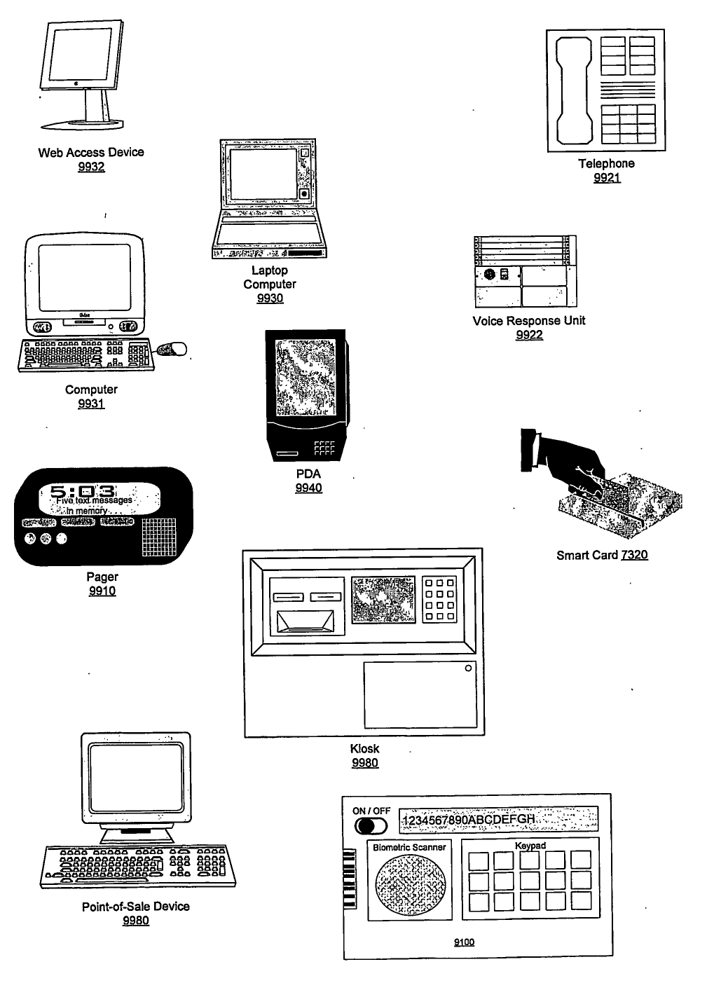

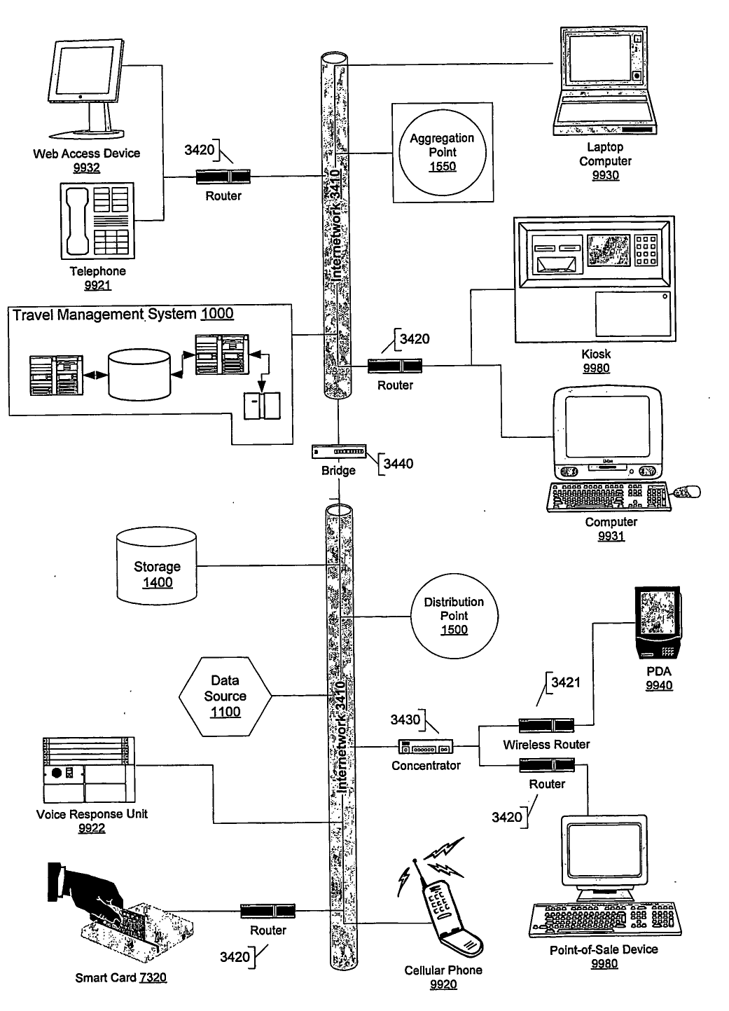

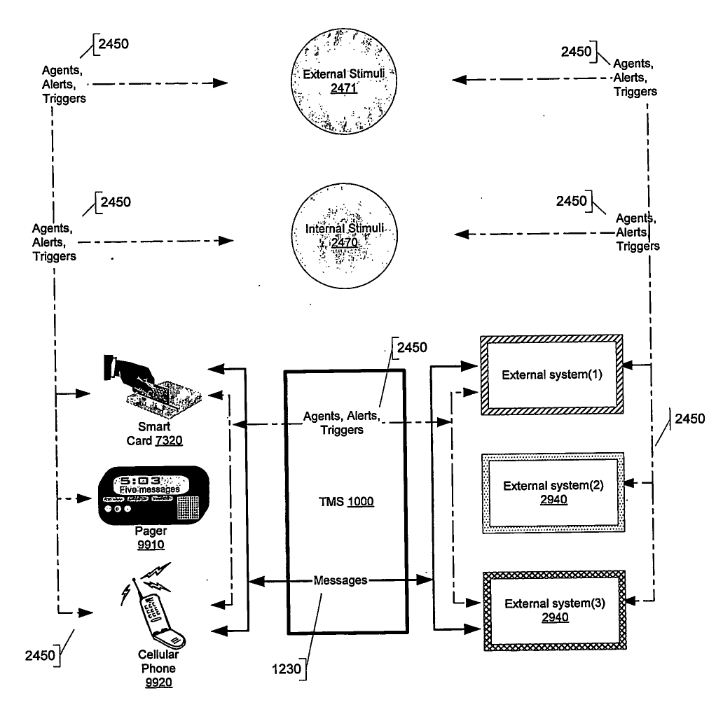

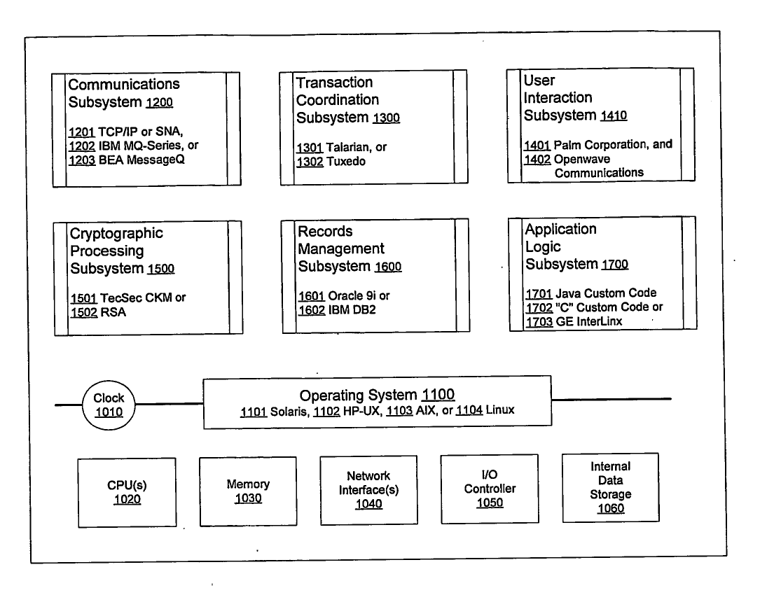

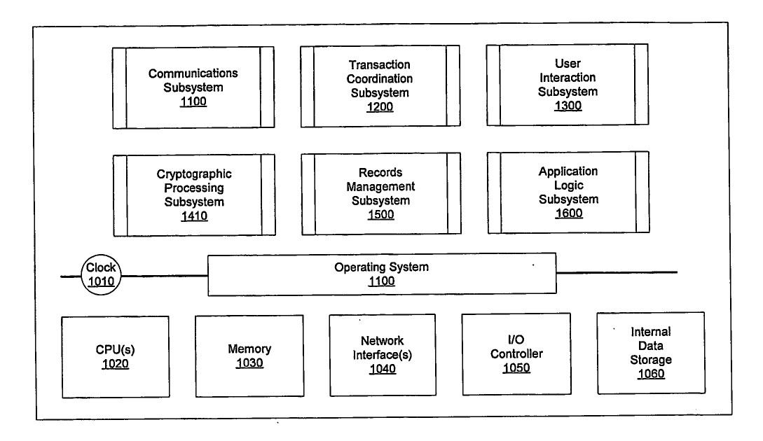

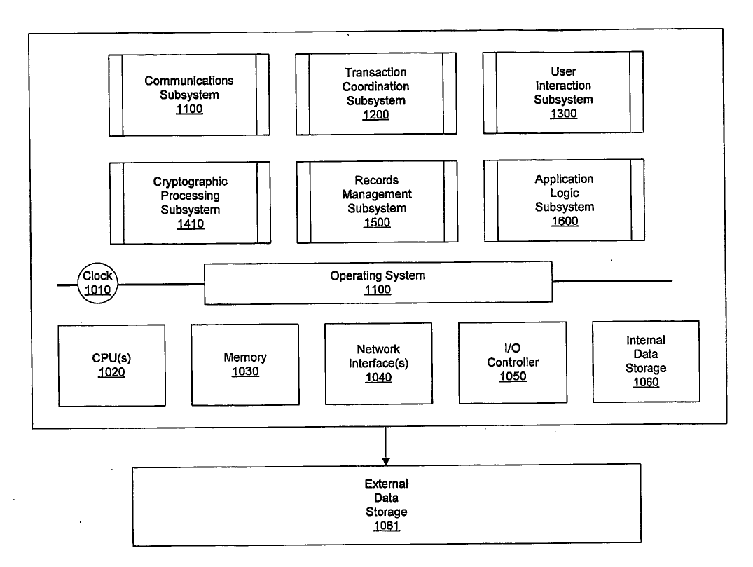

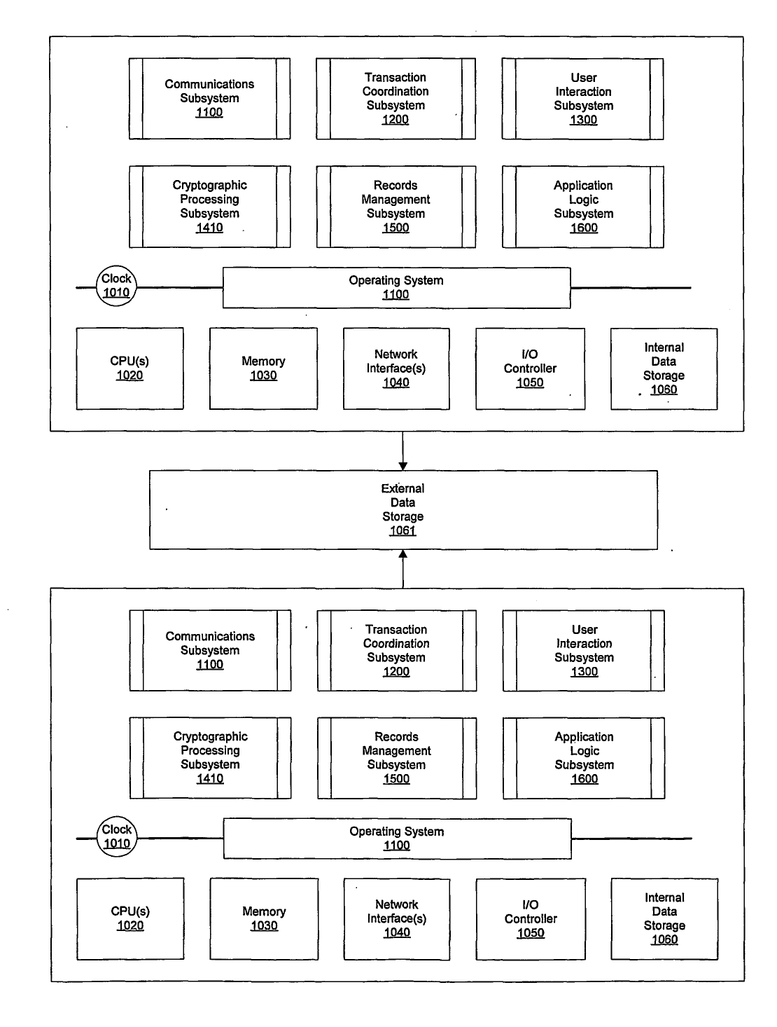

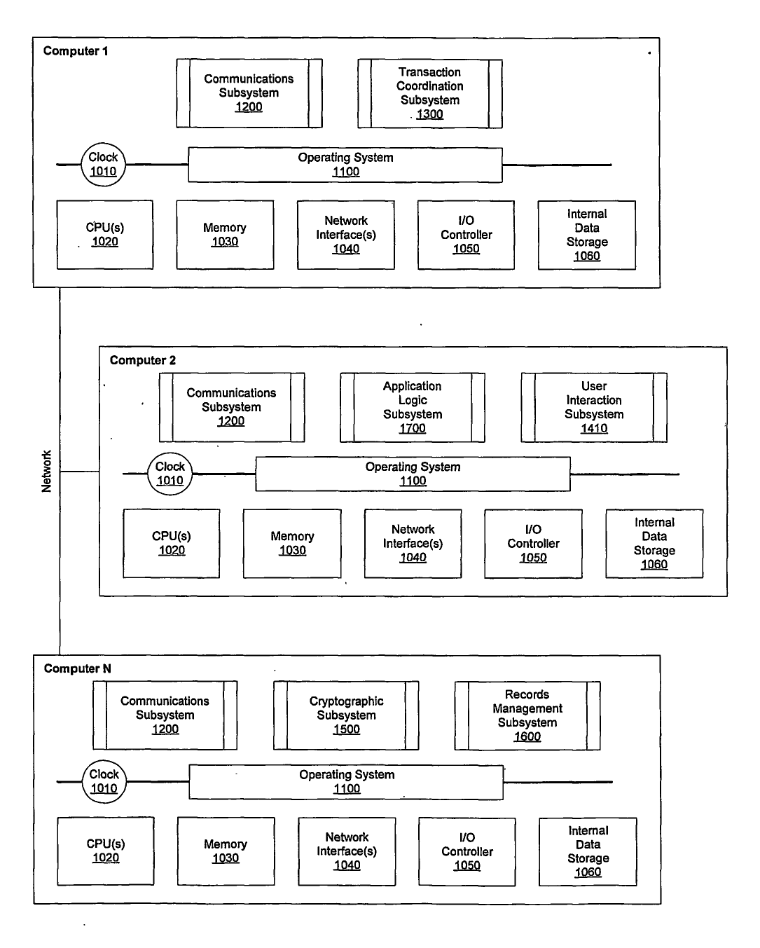

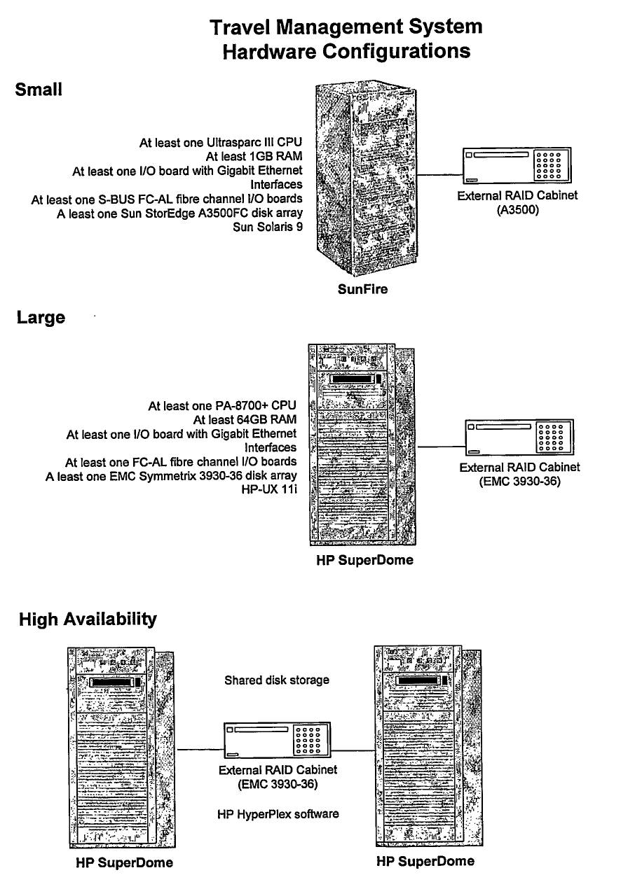

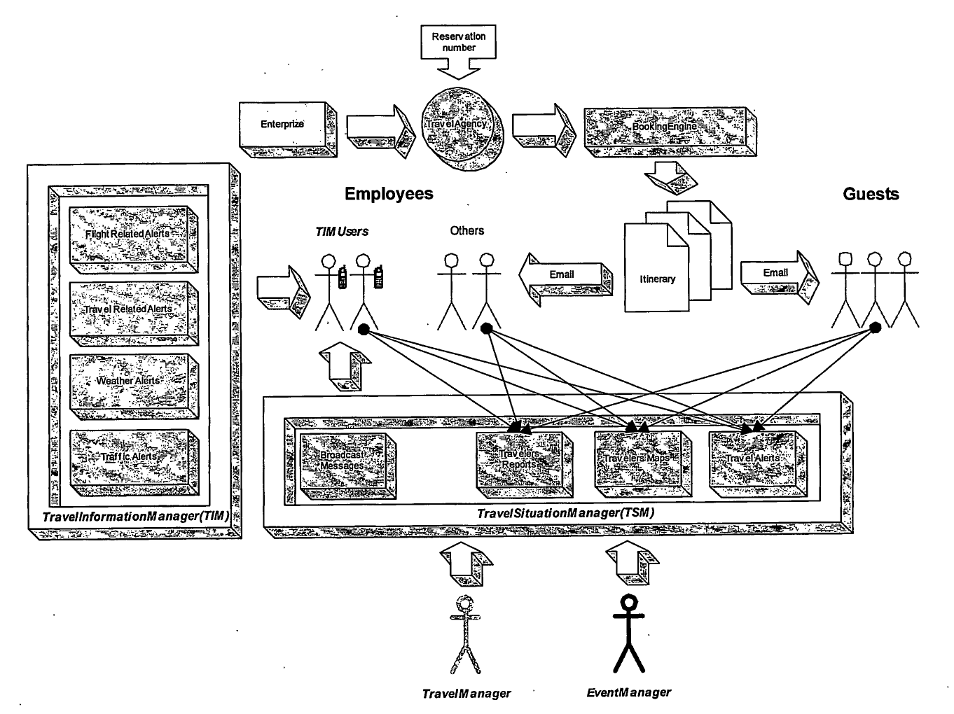

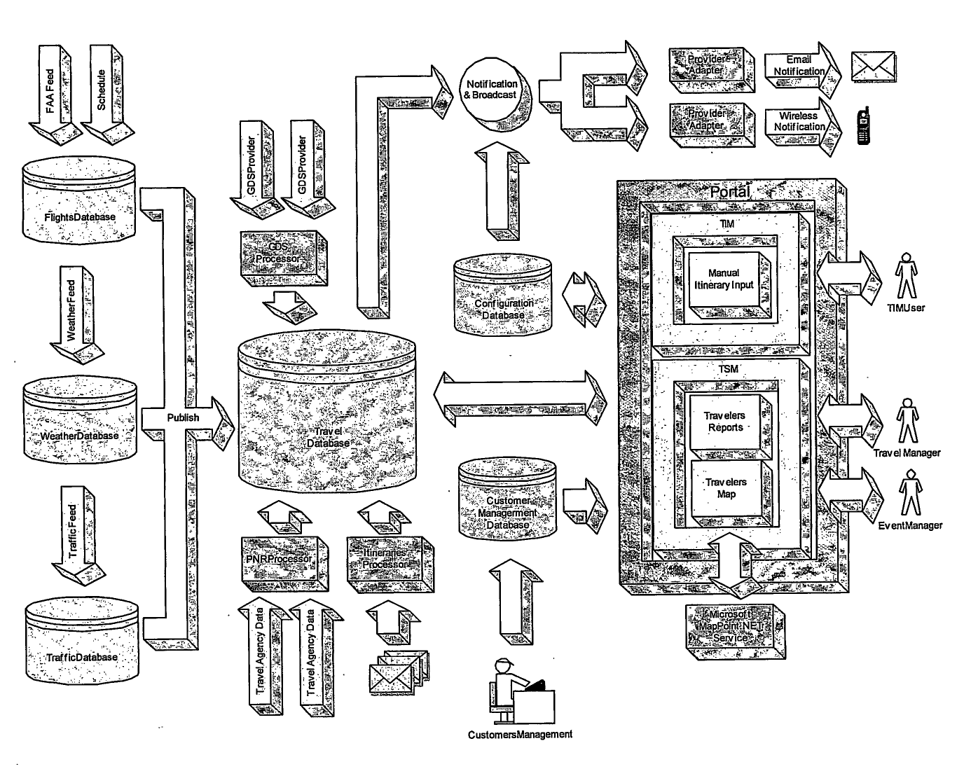

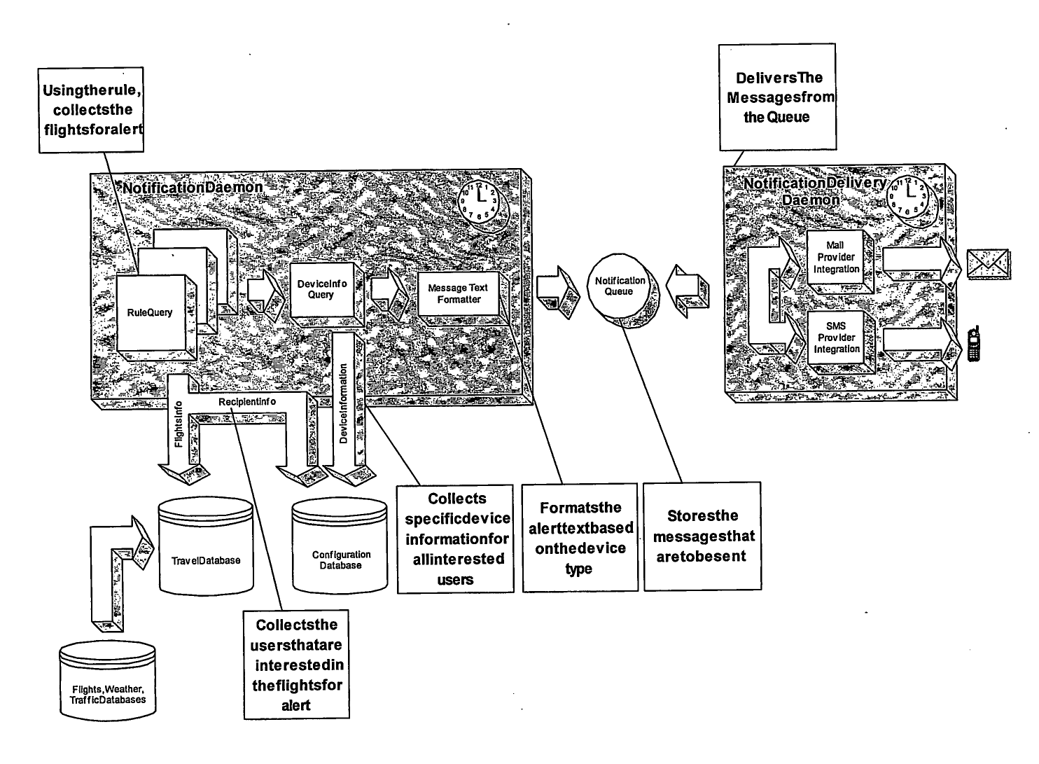

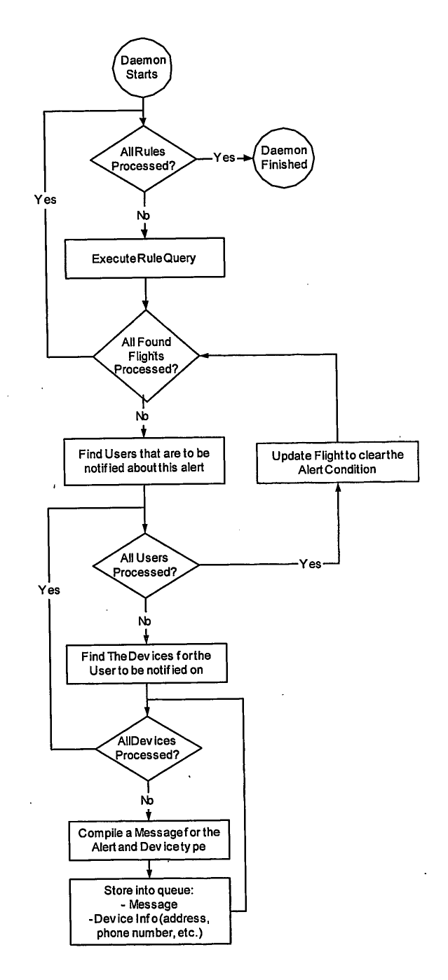

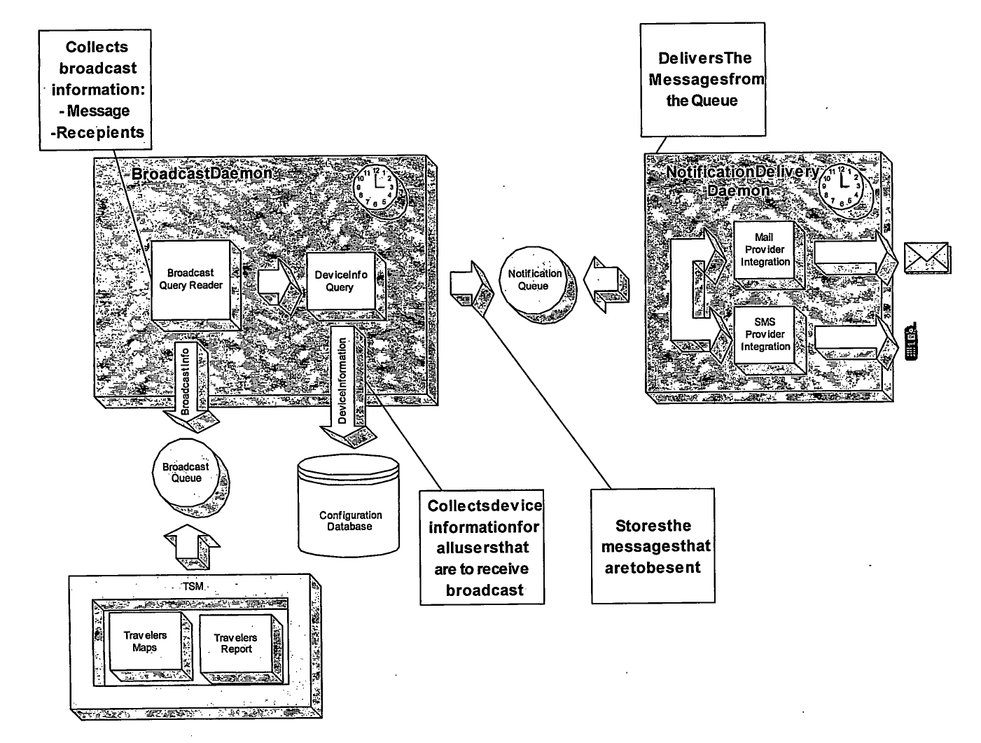

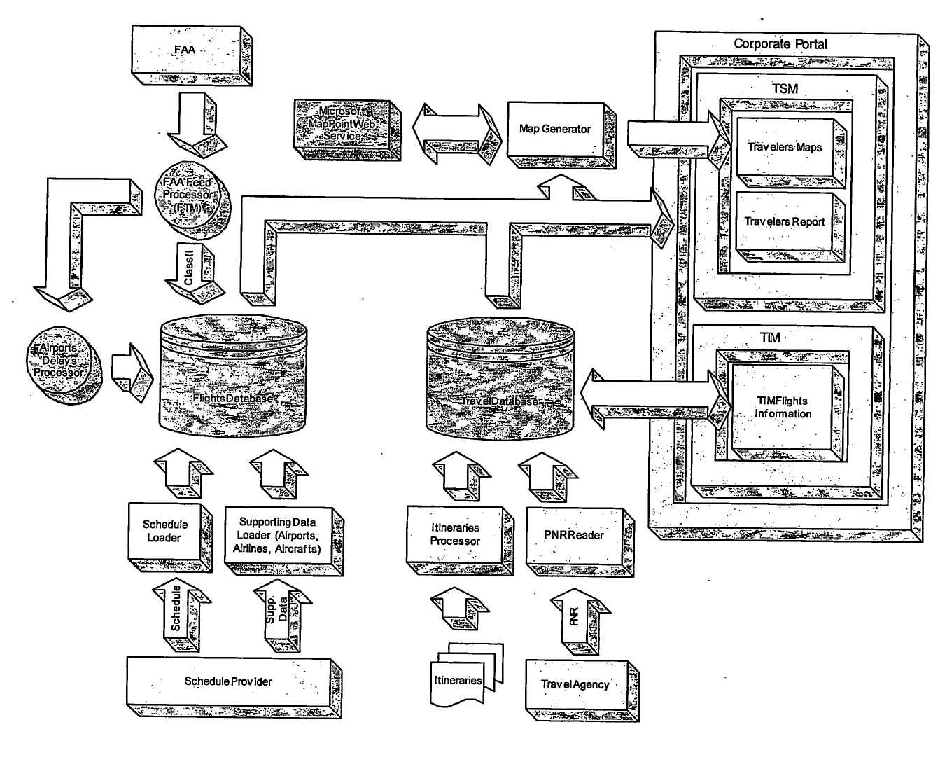

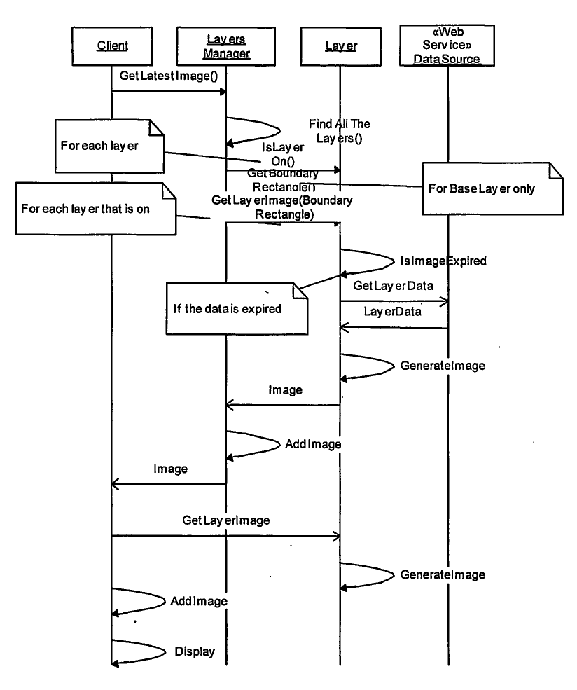

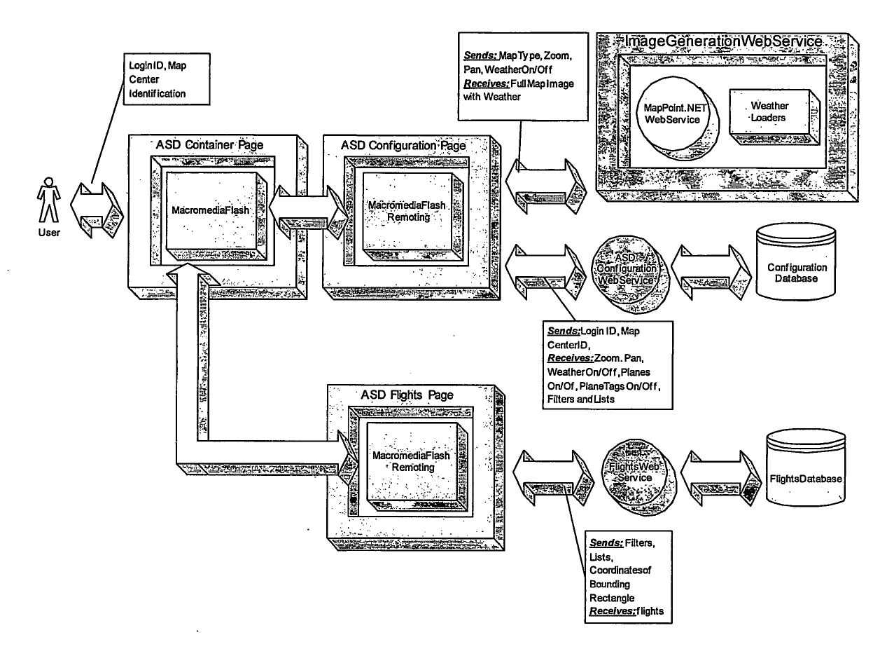

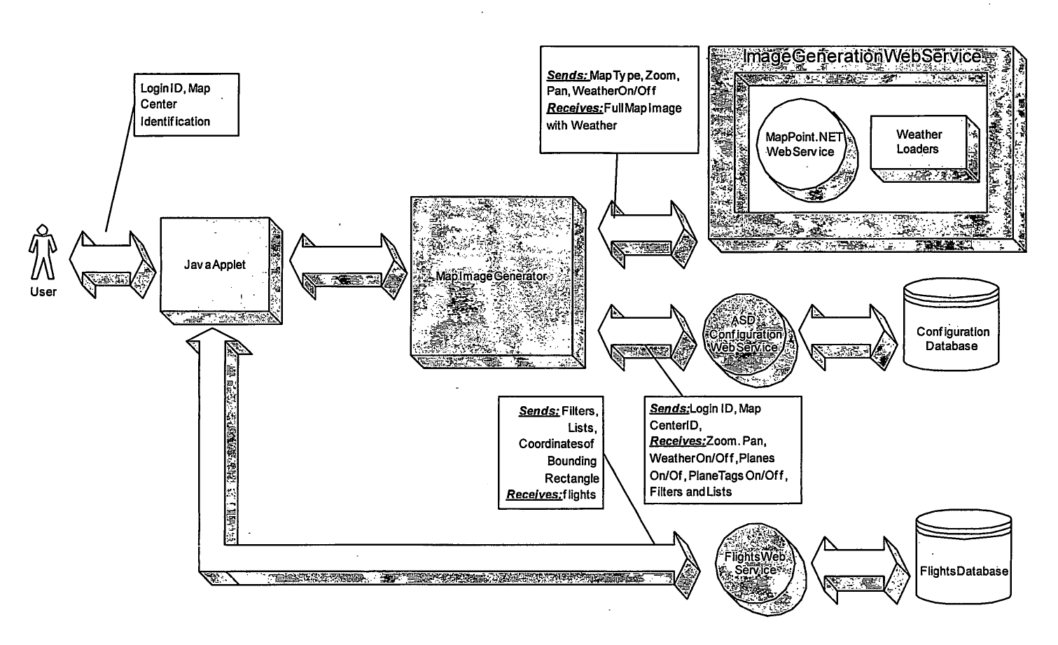

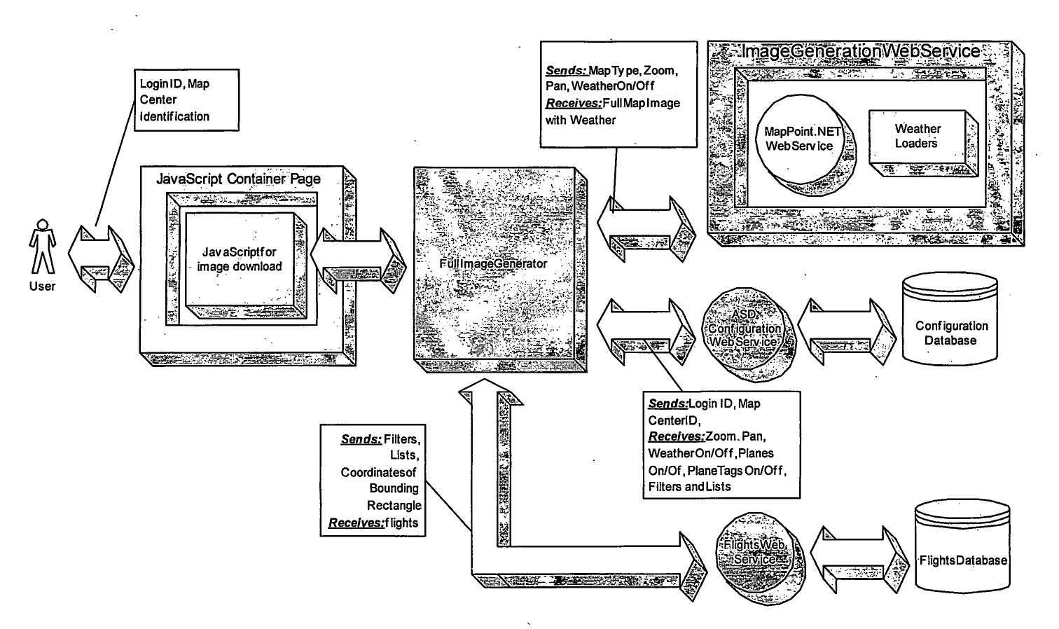

### GENERAL EMBODIMENTS

1.1 Overview

The present invention provides systems and methods for the acquisition, integration and management of data supplied by multiple, heterogeneous sources; single and multi-level exception handling, error correction, data enhancement, and data prediction; and fine-grained control of the distribution, access and display of this data to multiple users and non-users of the system as well as to system owners for the purpose of delivering travel related information.

The travel related information managed and manipulated by the system can be presented in several different ways, depending on the end user's needs. As such, the various permutations of the advanced travel management system's embodiments can effect a number of potential system types. However, certain of these embodiments support common capabilities regardless of the configuration of the advanced travel management system.

1.1.1 Real-Time and Near Real-Time Dynamic Data Warehousing

While Data Warehouses are built to process and/or transform data to accommodate post-entry analysis of the data, an advanced travel information system can be used to dynamically build and report from a data warehouse. In most typical data warehouses operations, processing and transformation is generally performed in a batch mode, usually in after-hours timeframe. However, an ATMS represents a Dynamic Data Warehouse where the data is processed immediately upon the receipt and may be delivered to the users in a real-time or near real-time manner.

1.1.2 Dynamic Passenger/Vehicle Association and Tracking

While older systems delivered the capability to associate a person with a particular vehicle, and by extension, the movement of that vehicle, these systems failed if the person or vehicle information had to be altered “on-the-fly”. For instance, if “Bob Jones” was supposed to have flown from New York to Chicago on United Airlines 863 on Thursday, previous system would be able to track UA 863, and its departure and arrival times. However, if Mr. Jones had to change his schedule, and left Wednesday on flight 863, or Thursday morning on flight 852, these systems would still most likely have tracked the original flight 863.

The reasoning behind this is quite simple: prior to the present invention, travel management systems were unable to create an “event” which tracked the data and meta-data surrounding a person taking a flight. In the present invention, the event is the primary tracking mechanism, with vehicle data and object (traveler) data tied together through the event. Thus, the event of interest is Mr. Jones' presence at a meeting in Chicago on Thursday, not his use of flight UA 863. As such, the current system can track Mr. Jones regardless of the flights (or even trains or buses) he might take, the route that he takes, or the number of stops between his start and final destination. More so, the system, knowing Mr. Jones “event” requirements, can offer him variations on his travel plan(s) based on any exigency or want. These capabilities are inherent in the instant system due to the fact that multiple, disparate data sources can be seamlessly combined, processed, and their output made available to users, like Mr. Jones.

The present invention allows for both the manual and automated creation and management of “events” which can comprise multiple traveling objects (e.g., people, parcels, boxes, letters), having travel requirements, and interacting with at least one vehicle. The objects do not need to be co-located, nor do the vehicles need to travel the same path or have any other association. Although the system allows for querying and reporting based on object or vehicle, the use of an event driven data model allows the ability to track multiple objects moving on multiple vehicles, where the objects and vehicles need only be loosely coupled, if that. More than that, the reporting mechanism for the instant system can be a visual display showing representations of real-time vehicles in motion, the objects relationship with the vehicle(s) in motion, and of both projected and/or alternate travel routes.

1.1.3 Web Service Based Data Access and Delivery

Users of older computerized travel management systems generally required two types of data access: if the users wanted to actually see travel information data on screen, they were required to install custom presentation software (business to consumer, or B2C); if they wanted to be able to use the travel information data as the input for their systems, they where more often than not required to construct elaborate programming interfaces between the travel management system and their corporate systems (business to business, or B2B).

Today, most existing travel management systems do not support both of these models; B2C systems generally require installation of a client component that is used to display the data, while B2B systems heavily rely on proprietary protocols that often are not firewall friendly, not secure, and hard and expensive to maintain. Also, even some of the travel management software providers can be forced, due to business realities, to maintain specific APIs just to allow the access to the source data. As a result, system installation, maintenance and integration become an ongoing task that is very resources consuming. Integration with such systems becomes especially hard when dealing with new types of devices with new operating systems for which Client Software/Access APIs are not available yet.

The advanced travel management system described herein solves these problems by using a web application/web services model. Based on standard HTIP/HTIPS communications protocols, the web services/web application model immediately eliminates most firewall/security issues. The web services that comprise the B2B portion of the system can be used directly by customer's systems or can be consolidated, aggregated and further processed by the other Web Services also available for a consumer of the services and data so provided.

The advanced travel management system also allows for B2C applications to be built using web services. However, to minimize the impact on a customer's systems, an ATMS would more typically deploy the customer facing portion of a B2C travel management system using a web application. In this way the display capabilities do not require a hard-linked terminals, nor the downloading and installation of custom software, merely the presence of a browser or browser-like capabilities.

The web service architecture allows for the dynamic, real-time aggregation of data, controls, and other static services (including non-web service applications and data), and affording a uniform outbound data set, data presentation, and/or user interface. Additionally, by providing data through a web service and web application, the present invention is completely device independent.

1.1.4 Dynamic Map Selection, Generation, and Display

An additional advantage of the web services architecture used by the present invention is the ability to dynamically select maps of multiple types from multiple different sources in real time as selected by the end user, and the ability to overlay other services and displayed data independent of the underlying image(s). This allows for the combination of different graphic types (e.g., raster, vector, bit-level), and the conversion of data from one graphic type to another without regard to limitations in the originating data source or the end-user's access/display device.

1.1.4.1 Objects and Layers

The present invention allows for objects (e.g., vehicles, passengers, weather data) to be assigned to one or more layers. The system can then present to the user a set of filters, through which the objects, or their layers can be turned on or off (made visible or hidden). The user has flexibility in control various aspects of each objects represented characteristics (e.g., color, size, icon) as well as for various parameters for each layer. Object/layer associations can be made globally for the system, can be assigned hierarchically (whereby “parent” associations control “children” associations), and can be managed individually for a particular user or a particular user's display or access device.

1.1.4.2 Moving Object Tracking in Real Time

The advanced travel management system allows for objects and events to be tracked in real time, with changes in the locations of objects or events able to be displayed in real time. As a web service/web application, the system is viewpoint agnostic. Thus, the system also allows for the creation of a “rigid” viewing window (representing the objects' perceived view of the world) through which a moving map can be tracked. Landmarks or other signification objects of events, either static or themselves moving, will have their apparent motions (velocities and directions) calculated “on-the-fly” so that the perceived motion from the point of view of the “static” moving observer is correct. Additionally, the generated image can be scaled, rotated, panned, zoomed, expanded, etc., in accordance with standard graphical capabilities. The system also allows the ability to have both the rigid viewing window and the focused object(s) moving at the same time, i.e., the viewing window is disassociated from any object.

1.1.4.3 User-Selectable Display Elements and Filters

The advanced travel management system has the ability display as little or as much detail as a user would like at any one time. Filter and listing capabilities let a user select one or more attribute, and join multiple attributes together to limit what is displayed. Filters and lists can be created that are both inclusive and exclusive. For example, from all of the enroute flights in the air at a given time, a user can request to have displayed only those flights that are Commercial, XYZ carrier, and are aircraft type MD80. Furthermore this same user could then specify to not include these flights if they're below 35000 feet.

In addition to being able to select what is displayed, a user can specify how (i.e.: what color code, what size, what detail of a datatag, etc.). The corresponding displayed map can show any one of a number of map overlays. Again, these maps can be scaled, rotated, panned, zoomed, expanded, etc., in accordance with standard graphical capabilities.

Further, each users' display can be configured independently from one another, even if they are observing the some object and event over the same geographic area. There is no limit to the number of different display views a group of users can have, nor is there a limit to the number of users that they system can support.

1.2 Access Methods

Specific embodiments of the main aspects of this invention permit the use of multiple communications devices, chained together in such a way as to allow an end-user the ability to access the system, or data presented by the system, and conduct transactions, from a variety of devices. Allowing disparate internal and external devices to communicate with one another affords a variety of multi-network configurations, all the while providing a seamless connection for the end-user.

In general there are three major sets of networked connections that have been presented in this invention: private networks, public networks, and private-over-public networks. A private communication network is not physically accessible to the public. A public communication network, such as the Internet, is open to all. Private-over-public networks establish secure and possibly encrypted connections, affording private communications over publicly accessible infrastructure. An example of a private-over-public network is the use of a Virtual Private Network (VPN) to bridge multiple sites using a public communications backbone such as the Internet.

It is likely that an inter-networked configuration of system modules and data stores would use a combination of all three communications technologies. Various storage systems, processing systems, data sources, distribution points, and/or aggregations points are likely to be interconnected on a private communications network connecting multiple, geographically dispersed redundant operations centers. These systems may be connected on a private communications network, but more likely, where guaranteed performance is not a requirement, would use a VPN. The VPN will guarantee secure, encrypted communications connections despite routing over potentially public lines. Firewalls and other security techniques will be used to protect private portions of the networks, but customers will need to be able to interact with the system. This self-service activity could be supported over public communications networks such as the Internet using web browsers or the phone network via touch tone and voice recognition response systems. Additionally, self-service activities could be performed using wireless Internet and phone networks through various input devices (e.g., hand-writing recognition systems for Palm-like devices; touch-tone, email, or voice recognition response systems for cellular phones). All three techniques may be required for the optimal configuration.

1.2.1 Private Networks

Private communications networks have long been used for the construction of financial networks. The advantages of private networks are the ability to provide physical security, the ability to run proprietary communications protocols, and the ability to limit access to the network to specific parties. The disadvantages of private networks are the significant construction and operating expense, the high level of maintenance required, and the need tb administer the infrastructure. Examples of private networks include the Apollo Reservations network which serves as the back-bone of United Airline's reservation system.

1.2.2 Public Networks

Public communications networks such as the Internet and the telephone network provide general-purpose connectivity that is well suited for customer self-service access and information distribution. The advantages of public communications networks are easy access from many locations, standard communication protocols, and distributed controls without any central point of failure. he disadvantages of public communications networks are unpredictable performance and minimal security. Other examples of public networks include the broad spectrum of cellular phone and other radio frequency networks.

1.2.3 Private-Over-Public Networks

Virtual Private Networks use encryption to provide networking that is effectively private over public communications channels. The advantages of a VPN solution are reduced costs (versus a private network), standard communication protocols, and the ability to limit access to the network to specific parties. The disadvantages of VPNs are extra expenses (over the cost of the public network infrastructure), including a moderate level of administration and maintenance required, and unpredictable levels of performance.

1.2A Communications Channels

A communications channel is a system over, on, in and/or through which a message is presented to or received from a communications device. Channels consist of both the physical systems necessary for transmission/receipt of messages and the protocol(s) required for proper processing messages.

Each communications channel may have its own specific protocol i5 requirements. Some communications channel may share protocols with other communications channels, but today, even when using identical protocols, their implementation is usually channel specific. For example, email systems typically rely on computers to format and send email messages, using the TCP/IP protocol for transmitting the email packets along the network, and the SMT? and MIME protocols for formatting the packets; email-enabled cellular phones require the further use WHTML and/or WAP protocols for display and interaction; Palm-based PDAs use the Web-clipping protocol.

1.2.4.1 Communications Channel Management

ATMS allows channel management that is protocol and system independent. Thus, ATMS messages can not only seamlessly transfer between different communications channels, but can also be simultaneously converted and transmitted via multiple communications channels.

1.2.4.2 Communications Channel Types

In preferred embodiments, communications channels can be of several types, 30 including but not limited to the following: electronic mail (email) systems, web browser systems, short message systems (SMS) including short text message systems, instant message (IM) systems, voicemail systems including voice recognition, voice-to-text, and text-to-voice systems, facsimile (fax) systems, peer-to-peer systems, chat rooms systems, and other systems including, but not limited to, telegraph systems, closed network payment systems, bank systems (e.g., savings, checking), and financial systems (e.g., debit card, credit card, secured and/or unsecured line of credit, ATM). They can also comprise combinations of the above mentioned and other channels.

In some embodiments, the communications channels can have store-and-forward mechanisms for delayed delivery or forwarding of messages using a queue, buffer, or post office/post box. For example, an email message can be stored or queued, online or offline, in an electronic post office waiting for later retrieval on demand by the message recipient. In particular examples, these messages can also be altered while stored, for retrieval through different communications channels, such as an email message retrieved through a voicemail system using a text-to-voice converter.

In other embodiments, the communications channels can have real-time or near real-time mechanisms for immediate delivery of messages. For example, a voicemail message can be delivered instantly or quickly via an instant message system after conversion through a voice-to-text engine. Communications channels can also have notification schemes and/or indicators that allow recognition and/or acknowledgement that messages are available or pending. For example, a notification of a pending voicemail can be delivered to a cell phone, without requiring the delivery of the underlying message.

1.2.5 Communications Devices

Communications devices are the “user-touchable” components in a communications session. These devices may be connected to a channel, permanently, periodically, sporadically, or ad hoc (as necessary). Devices include direct access devices that are hard-wired and indirect access devices (radio frequency-based, infrared-based, etc.)

In most preferred embodiments, access devices are categorized into major classifications of: self-service devices, agent-operated devices, distributed devices, and stand-alone system devices.

Self-service devices include, for example ATMs, telephones, fuel pumps, vending machines, kiosks, electronic commerce (including phone, wireless, and web), as well as ticketing and ticket dispensing machines.

Examples of agent-operated devices include retail point-of-sale (POS) devices, cash registers, billing systems, collection systems, banking systems, government offices accepting fees, fines, and taxes, as well as services provided by vendors including accounting, legal, and other support services.

Illustrative of distributed devices are wireless devices such as pagers, cellular and other portable phones, personal digital assistants (PDAs), laptop computers, desktop computers, network computers, network appliances, set-top boxes for televisions, and satellite systems.

Stand-alone system devices include, for example, smart cards, fare cards, electronic wallets, memory sticks, and secure device memory cards (SDMC)

1.3 System Elements

1.3.1 Encryption & Security

Encryption can be invaluable in the operation and management of an advanced travel management system. The ATMS, as a unifying management tool for large sets of disparate data from multiple sources, can be protected from unauthorized access and manipulation that might compromise the integrity of the data. Additionally, since of this data will be distributed to end-users and other systems, the communications channels and the transmissions themselves are preferably secured to insure that only valid ATMS actions are accepted and processed.

Specific embodiments of this invention allow for the creation of secure systems wherein data (both system data and operational data) can be encrypted in transit, at rest, or during processing. In certain particular forms of these embodiments, multiple layers of encryption, e.g., stored encrypted data that is encrypted a second time during transmission, are also supported. In most instances, all data pertinent to the operation and well-being of the system is encrypted, although certain embodiments allow for cases where non-sensitive data remains unencrypted

These encryption services can be provided in hardware, software, or a combination of hardware and software. Encryption engines may be internal or external to the computer system, or may be included within one of the various subsystems. Encryption and decryption duties can be split between multiple encryption engines without loss of security. Use of a particular encrypting/decrypting system does not preclude the simultaneous use of other encrypting/decrypting systems.

1.4 Agents, Alerts & Triggers

In preferred embodiments, agents, alerts and triggers are available to all systems based on an ATMS, and to certain objects within the systems contemplated by this invention. Additionally, these services can be offered in pre-packaged templates, and as various types of user-defined, user-selected, and user-determined services.

1.4.1 Alerts

Alerts are real-time messages generated by system events, or created by observers of events or current conditions, usually in response to pre-defined thresholds. Alerts can be as simple as a notification of a successful transaction completion (e.g., a flight has arrived on time), or the availability of an earlier flight. More complex alerts can be generated in response to observed conditions, such as the generation of an alternate route or travel plan due to inclement weather. Alerts can be generated in response to a system activity, and can also be generated as reminders of time-sensitive requirements, such as the renewal of a lease, the transfer of a deed, the renewal of a credential, the expiration of a travel option.

Alerts are normally generated in real-time and can be responded to automatically in real-time using triggers or agents. Alerts can require a response or may be purely informational. The alert may establish a stream of information or be a discrete message. When streams of data are provided, such as a conditional travel data, the alert is used as a conduit to assure a free and uninterrupted flow of information.

Alerts may be time synchronized and thus guaranteed to arrive in a specific order, or they may be asynchronous, allowing for any order. Queuing mechanisms are typically used to propagate alerts and may include various synchronized ordering schemes such as last-in, first-out (LIFO) and first-in, first-out (FIFO) queues.

Alerts can be marked as undelivered or delivered. Delivery flags can be used to indicate which alerts have been previously examined, but not deleted, and which alerts have never been examined. Undelivered alerts can be set to automatically expire at a future date and time. An example of an automatically expiring alert might be the notification of a coupon or time sensitive discount offer that expires at the same time the coupon or discount expires. The receipt of a more recent alert related to the same topic can also cause expiration of the previous alert. One example of alert updating would be the replacement of a due-in notification (indicating the imminent arrival of previously ordered items) by an arrival notification (indicating actual receipt of the items). Another example might be a notification of a package waiting for signature that is updated every four hours with each update automatically causing the prior alert to expire.

Alerts can act as containers for carrying information or documents of interest to at least one recipient. The alert acts as a message header indicating the kind of content and perhaps providing summary level information or routing instructions. The content of the alert may be encrypted separately from the alert itself. For example, an alert may arrive from a billing system containing an encrypted travel voucher for a specific individual.

Alerts are valuable because they identify actions that have occurred, situations requiring remedy, or information of interest. Alerts are also valuable because they can act as carrier containers to deliver valuable information and documents. Without alerts, system users would have to manually search for information to see if a situation had happened already or potentially might happen.

1.4.1.1 Internal and External Alerts

An alert can be communicated or attached to any system component, data element or control code, as well as, communication sessions, communications channels, and communications device. Alerts can be generated internally by an ATMS. These events can be propagated from one channel or device to another. Events can be generated interchanged and propagated through as many intermediaries as necessary to reach the intended alert respondent.

Alerts can also be generated by external systems and devices, which include but are not limited to externally interfaced systems, information providers, and interface devices. These external systems may be linked directly or indirectly to the ATMS. External devices can also create alerts related to their status or pending transactions with which they are involved.

1.4.1.2 Broadcast Alerts

Alerts may be broadcast to a preset list of subscribers, to all other known parties, to a subset of all known parties using some selection criteria, or to a channel. Channel broadcasts allow parties to connect and disconnect with the channel at will to listen in real-time or near real-time alerts. Channel broadcasts are often used to monitor weather conditions using sampling techniques or to watch for changes in status of specific flights.

1.4.1.3 Alerts Interfaced with Messaging Systems

Some alerts may be automatically displayed in chat rooms or similar scrolling window displays. Other alerts may be displayed using ticker interfaces, charts, graphs, or pop-up displays. In other interfaces, an icon may appear indicating the presence of an alert that can be retrieved at user request.

1.42 Triggers

Triggers are predefined action templates that are used to automatically respond to detected conditions. Simple triggers can be used to automatically implement contingency plans, e.g., if the first leg of my flight is cancelled/delayed, make the appropriate changes to the remaining flight legs. Other triggers can be used to automatically connect and disconnect disparate devices during a communications session as devices change geographic position. More complex triggers can be defined to which require multiple inputs to become active, and implement multiple potential outcomes.

Triggers can be chained to perform jobs. Each job step may be or include a discrete trigger with a specific execution condition(s) that include(s) a test of the success, failure, or status of the prior step. Job step triggers can be linked to invoke other specific triggers synchronously, asynchronously, and/or in parallel.

1.4.2.1 Triggering Conditions

Triggers can, for example, be caused to activate (test a set of conditions and conditionally perform at least one actions) as a reaction to alerts, as a result of a clock event, as the result of a change in geographic position, or at the request of an agent. Triggers can activate in response to the detection of specific kinds or types of alerts such as a specific “delta” between planned and expected arrival times, communications channel unavailability, or external messages. Some triggers monitor streaming alerts for threshold conditions that are based upon formulas or other mathematical equations. Clock events can also cause a trigger to activate, based on, for example, elapsed time (e.g., every n minutes, every x days, every z weeks), at specific times (e.g., market open, 10AM, midnight), at specific dates (e.g., Jan. 1^{st}, Apr. 15^{th}, Dec. 25^{th}), or on specific days of the week (e.g., first Monday of the month, every Friday, third Thursday).

1.4.2.2 Action Templates

Triggers may be based upon pre-defined action templates that can take many different forms. Some may be simple built-in automation switches that are turned on globally for all accounts and sub-accounts in a hierarchy of accounts, or all devices and channels connected during a communications session. Examples of global automation switches include those for automatic forwarding of messages and other alerts, for automatic propagation of all alerts to a parent in the hierarchy, for filters to delete or acknowledge alert types or to delete categories of alerts deemed to be uninteresting.

Other triggers may be more specific to an individual or device's conditions. For example, a trigger may exist which imposes additional constraints when certain conditions are found.

1.4.2.3 Internal and External Trigger Evaluation

Triggers can be evaluated and/or processed in external systems. Evaluation refers to testing the conditions specified within the trigger; processing refers to taking action to implement the goals of the trigger. This allows triggers to affect accounts, devices and channels linked to external systems via proxy relationships. It also allows trigger activity to be separated from internal controls to improve security.

1.4.3 Agents

Agents are automated assistants that perform inquiries and take actions on behalf of their owners. Agents can be used for many things, including but not limited to seeking out the best prices from multiple sellers, or automating participation in an event.

Agents can be proactive or reactive. Proactive agents actively scan, search, or peruse information sources for goods, services, alerts, and information that meet their objectives. Reactive agents wait for notification of an event, for example, by an alert or by a clock timer tracking elapsed time, waiting for specific dates, or waiting for specific days. Agents can have components that are both proactive and reactive.

Agents can create and propagate alerts to notify other agents or users of the results of inquiries or transactions. Agents can use alerts to request authority to proceed with specific lines of inquiry, negotiations, or transactions.

Agents can be independent or dependent. Independent agents contain code allowing for mobility or replication. They can jump from system to system while pursuing their quest. Dependent agents stay in a single location, but request information and perform transactions with remote systems by communicating with them.

### SPECIFIC EMBODIMENTS

Certain unique features and advantages afforded by advanced travel management systems are most readily understood when multiple embodiments are considered together.

A first set of embodiments involves the advantages afforded by this invention are detailed in the operating of a travel information management system.

A second set afforded by this invention's embodiments are detailed in the use of a travel situation manager.

A third set of embodiments lists the advantages afforded by a real-time object situational display.

1.5 Trip Information Management System

A Trip Information Manager (TIM) is a traveler-focused application of several embodiments of an advanced travel management system, and offers numerous advantages over existing systems. Perhaps most importantly, it saves both consumers and businesses time and money by informing members of a traveler's community of the traveler's trip's progress. It increases travel efficiency by increasing a traveler's awareness, and allows the traveler to anticipate problems and take action quickly. Providing a traveler with updated information saves money and improves the quality of travel.

A TIM can track a traveler's itineraries automatically and can coordinates trips against a built-in contact management system. The contact management system can be a stand alone application, can be maintained as part of the TIM, or can be an application owned and operated by the traveler (or the traveler's company) with either a tightly or loosely coupled integration to the TIM or TIM's data. It can be configured to continuously check the trip, from beginning to end, using data obtained from numerous data sources. A TIM can identify many problems before they happen, such as a canceled or delayed flight. Also, since the TIM is a web service/web application, the information regarding discrepancies in planned (versus actual) travel itineraries can be presented in a form and through a device most convenient to a traveler, for example, graphically on the traveler's corporate portal, email or wireless device.

A TIM is the perfect companion for dealing with expected and unexpected travel related events. Using agents, alerts, and triggers, it can actively monitor the traveler's itinerary and provides useful data for making informed decisions in real-time, and can notify not only the traveler, but designated other system depending upon proper completion of the travelers itinerary, such as chauffer services, who could be notified when a plane is scheduled to arrive late. A TIM-enabled traveler can execute his travel with confidence and awareness. By continuously monitoring a wide range of conditions such as flight cancellation, flight changes and weather, a TIM ensures the traveler is aware of events before they become critical.

1.6 Travel Situation Management System

A travel situation management system (TSMS) is a corporation and travel manager facing application of several embodiments of an advanced travel management system. A TSMS provides a real-time traveler and event tracking dashboard which provides a graphical overview of all en route travelers, events, and locations, as well as associated detailed textual information. By combining both graphical and textual information in real-time in a consistent user interface, a TSMS provides travel manager to proactively manage employee travel—delivering a more efficient, and cost effective traveling experience.

One TSMS system based on an advanced travel management system currently available is FlyteComm's Traveler Situation Manager™ (TSM™). Flytecomm's TSM provides a visual display which shows at a quick glance the current location of all en-route flights carrying company employees. The TSM Map includes “mouse over” display boxes that list names of company employees and the current flight status. This feature provides, Travel Managers with a real-time, instant view of the company's business traveler's location. Also shown on the TSM map are the current departure and arrival delays for the top 100 airports.

Real-time, on screen information updates can be requested and sent to Travel Managers. The data can be sent via email or SMS device to inform them of potential issues that may interfere with their travelers. Other activities may also be impacted by flight changes—off-airport transportation, traveler coordination, hotel check-in or business meetings. Armed with these advance warnings, Travel Managers can proactively manage all aspects of their traveler's trip, allowing them to make real-time adjustments and avert problems before they occur.

FlyteComm's TSM also embodies several other advantages contained within an ATMS, including:
Web services/web applications: TSM is built using a web services model for data acquisition, processing and storage, while the Travel Manager's user interface is a web application.
Mapping application service: As an example of one of the web services used by TSM, the map detail is dynamically requested, calculated and display via Microsoft's Map Point. At any time however, should the need arise, TSM can instantly change to any other mapping web service in order to generate client maps.
Layered data: This embodiment of the invention allows for multiple layered objects, which can each be independently manipulated and queried. In this instance, Macromedia's flash technology is employed and augmented to allow for multiple layering of different objects, views, maps, personnel, equipment, etc., over a currently-displayed, underlying map. There are no limits to the number of layers that can be displayed at any given time, nor the number or type of objects that can be associated with a layer.
Static data and dynamic data: The TMS is quite robust in that it can handle, compare, mix, and calculate against both static and dynamic data.
Weather information and data: Weather information is pulled on regular intervals from a service provider and worked into the system in two ways. A graphical map overlay is created that can be toggled on/off from a map display. Additionally, a textual data set is logged for visual presentation upon user request. Besides the acquisition and re-display of this data, FlyteComm's TMS monitors changes in weather data and automatically executes notifications, forecasts delays, etc., based on these changes.
Passenger information: This embodiment of an advanced travel management system is designed to be ultra-flexible in acquiring, accessing, and storing passenger information. Passenger information can be created manually in the system or can be input and/or refreshed (either at pre-scheduled times or in real-time) via automated processes incorporating agents, alerts, and triggers.
Passenger Information Broadcasts: Messages containing information pertinent to a passenger's particular event can be automatically created and broadcast, via multiple devices and across multiple communications channels. Device and channel independence afford greater flexibility for travelers and travel managers increasing the chances that a message will get to its target in a timely fashion.
Airport status via mouse over: When an airport layer is activated over a map, the act of hovering over or in some cases clicking on an airport displayed will result in a description box being created that details all of the airport's relevant information. For example, “mousing over” San Francisco International Airport (SFO) on a foggy day may create a description box showing that SFO is experiencing a 45 minute departure delay.
Traveler defined filters: The TSM allows for both system and user-defined filters, which can be used as either saved sets or in an ad hoc manner. Filters can be helpful in that they can limit the information displayed to a specific target subset of the total information stream, e.g., only showing United Airline flights that are inbound to ORD which departed from SFO.
Associates passenger with planes: One of the TSM's more profound advantages is its ability to associate a passenger with an event. In particular, by combining multiple data feeds from disparate sources both real-time and batch, passengers can be uniquely associated with a particular flight which will allow them to achieve their travel goals. If the flight(s) changes (either through delays or cancellations), the TSM can be automatically updated to account for these changes, and provide notices and alerts to both the affected passengers and their travel manager.

Additionally, the TSM can be configured to allow both guests and users access of the system.

1.7 Real-Time Object Situational Display

Another application containing several prominent embodiments of an advanced travel management system is a real-time object situational display (RTOSD). Properly configured, a RTOSD is a web services/web application which can provide a real-time view of an object and data pertinent to the object, along with any event specific information necessary for properly evaluating the object's condition.

A presently available commercial example of an RTOSD is FlyteTrax II. FlyteTrax II is the only browser-based flight tracking and weather display system. It utilizes FlyteComm's innovative Moving Map™ technology to provide a clear, real-time view of the air space overlayed upon any one of several map layers.

Accessible from any PC using a standards compliant browser, FlyteTrax II is powerful and easy to use, and has proven to be the perfect tool for flight dispatch departments, corporate flight departments, limousine operators, FBO's and anyone needing real-time flight status information. FlyteTrax II allows users to plan more effectively, better respond to delays, and save valuable time and resources in meeting customer needs

The system allows for extensive filtering capabilities, designed to allow users to customize the graphics displayed and only show those items important to at that particular time. FlyteTrax II also contains an integral text-based information component (the Flight Information Display, or FID) which can be synced with the graphical display. Users have the ability to incorporate filters on both the graphical display and the FID. Additionally, the system allows for the maintenance of historical data, and the ability to generate reports on the historical data, and perhaps more importantly, the ability to generate predictive reports for proposed future scenarios based on the historical data.

The FlyteTrax II system offers a wide range of display options, including multiple map windows, each with a different zoom setting, airport focus, map type, filter set, etc. Each map window can be independently updated, moved, or changed without requiring an update or refresh of the application or any of the other map display windows.

Some of the key features and benefits afforded by this system include:
Web services/web applications: TSM is built using a web services model for data acquisition, processing and storage, and a web application for the user interface. Thus, there is no client software to maintain or install, and the system can be accessed from any device capable of running a browser or affording browser-like capabilities.
Powerful Aircraft Situation Display (ASD): The main ASD view (the graphical portion of the web application) can be customized by the end user to meet specific needs, including: flights displayed, colors, map type, zoom level, weather options and more.
Integrated Flight Information Display (FID): Affords users the ability to view flight information from both the graphical map view as well as a textual listing of both en-route and proposed flights.
Airport Zoom Feature: Multiple pop-up windows, allow users to zoom in on specific airports while maintaining an overview look on the main screen.
Multiple map views: Map data is served on an as need basis, an can be acquired from multiple independent sources. FlyteTrax II currently utilizes Microsoft's MapPoint™ technology, which allows worldwide maps available in 9 detailed options.
Searches: Powerful filtering tools allow refined searches from single aircraft to the whole air space. Multiple filters can be overlaid, with sets of filters savable and shareable.
Weather Overlays: Satellite and Radar overlays provide a realistic view of the air space.
On Demand Reports: Instantly create real-time reports that allow management to make better decisions on allocation of resources.

Additional FlyteTrax II advantages include:
Flicker free screen refresh with moving map: Current web applications require the user to refresh the data in their browsers in order to see the data update. FlyteTrax II employs new, innovative no-flicker technology. By using background download capabilities for refresh, the data on the screen is completely dynamic, seamless and flicker-free; the system is capable of displaying highly dynamic moving map images without a single refresh of a browser screen.
Landmark and object lookup: FlyteTrax II utilizes the data stored in a centralized storage to provide the customers with the lookup capabilities based on significant landmarks, airports, and/or specific aircraft, as well as other identifiable system objects.
Create multiple lists of specific aircrafts: Users may choose to always display the particular flights by adding them to a list. Furthermore, the system maintains a plurality of lists allowing the ability to enable/disable a particular list as needed.
Pop-up data tags: In order to simplify presentation FlyteTrax II generally displays very short, basic information about each flight on the map. However, users can obtain extended information by using a variety of pop-up tags, which can be customized to display object specific information as well as event specific information pertinent to that object. The system also maintains the proper position of the tags and the tags association with its object regardless of the movement of the object on the display.
National radar mosaic and/or satellite image overlays: Per user request, FlyteTrax II maps can display the dynamic overlay of the weather data refreshed on periodic basis.
Variable zoom from 5 to 3,000 miles.
Detailed runway views for most airports.
Airport and aircraft activity reports: FlyteTrax II maintains archives of user selected airport and aircraft activity data, allowing a user to run activity reports for the past and present situation, and prediction/simulation reports for proposed future situations.

### DEFINITIONS

The following terms are defined so as to provide a reference to readers in their review of other text in this application.

| | |
|---|---|
| Alias | Any symbol, for instance at least one letters, numbers, characters, patterns |
| | or biometric readings that represents an entity without identifying it |
| Alphanumeric | Any symbol, which consists of any combination of letters and digits and |
| | possibly certain punctuation marks such as commas and/or dashes |
| Authenticating token | An authenticating token is a token of any kind, such as a PIN or password, |
| | that signifies the authority of an entity that employs it to take at least one |
| | forms of action, for example in or with respect to an account, a virtual |
| | account management system, any other form of advanced asset |
| | management system, a clearing house, a naming service, any other |
| | system included in or cooperative with any of the foregoing or any |
| | combination of the foregoing. |
| Bridge | A networking device used to connect two separate networks together such |
| | that they appear as one logical unit to devices on either side of the |
| | connection |
| Closed system | A system that allows interaction only among a defined group of participants |
| Communications | A communications channel is an assembly of devices and protocols which |
| channel | contains the ways and means for sending and/or receiving messages from |
| | one device to another. It contains functionality from several layers of the |
| | OSI network reference model, including the data link network, transport, |
| | and session layers, and can also incorporate functionality from the |
| | presentation and application layers. |
| Communications | A device of any type, including without limitation modems, routers, |
| device | keyboards, keypads, card readers, infra red “open air” transmitters and |
| | receivers, and optical fiber senders and receivers, through which it is |
| | possible to convey information to and/or from a computer system or a |
| | portion thereof, such as may be required for the operation of an account |
| | management system, of any other form of AAMS (Advanced Asset |
| | Management System), of a clearing house, of a naming service, of any |
| | other system included in or cooperative with any of the foregoing or of any |
| | combination of the foregoing, whether such information constitutes data |
| | and/or code. |
| Concentrator | A networking device used to merge at least two separate communications |
| | channels into one consolidated communications channel |
| Constraint | A restriction or rule that when enforced compels the constrained entity to |
| | avoid or to perform some action |
| Cryptography | The enciphering and deciphering of messages in secret code or cipher |
| Decryption | To cryptographically convert data from code to plaintext |
| Distributed system | A system in which processing occurs at more than one location in a |
| | coordinated fashion |
| Distributed, federated | A system in which members of a group, processing at many locations, |
| system | agree to some form of centralized management and minimum level of trust |
| | between members of the group but retain control of their own internal |
| | affairs |
| Domain | The mathematical set of entities that defines a sphere of influence |
| Email | One of the more common communications channels, email consists of a |
| | collection of several applications and protocols which are used to control |
| | the format and transmission of a message, and sometimes the contents of |
| | and/or attachments to a message. The applications can be server-based |
| | or client-based, with the client-based applications accessible on numerous |
| | types of devices. Additional protocols can be incorporated in order to |
| | extend the types of devices that send/receive email. Most email systems |
| | operate in a “post office” fashion, storing and forwarded messages. Email |
| | systems typically contain text-based messages, but can incorporate some |
| | graphic elements, or at least the ability to display some character |
| | combinations as graphics. The user accessible interface for email systems |
| | can reside on computers, PDAs, pagers, and various other devices. |
| Encryption | To cryptographically convert data into a code for security purposes |
| Encryption Engine | A device or process in which an algorithm cyrptographically converts input |
| | date/code into output data/code that is unrecognizable as compared to the |
| | input data/code. The algorithm can be physically embedded in a device |
| | (hardware), can be contained as programming code (software), or can be a |
| | combination of the two. In any form, the encryption engine can be a stand- |
| | alone system, a unique device inserted into a system, or can be integral |
| | component of some other device. Multiple encryption engines can be used |
| | simultaneously for various levels of encryption, and/or to accomplish |
| | encryption for different tasks or processes. The same or different |
| | encryption engines can be used to decrypt the converted data/code |
| | depending upon the algorithm used by the originating encryption engine. |
| Entity | A discrete unit that can be considered apart from its properties, for example |
| | an individual, partnership, association, corporation, government, |
| | government agency, other organization, communications device or other |
| | equipment |
| Expression | Something that manifests, embodies, or symbolizes something else |
| Federated system | A system in which members of a group agree to some form of centralized |
| | management and minimum level of trust between members of the group |
| | but retain control of their own internal affairs |
| Hub | A networking device that joins communications lines together in a star |
| | configuration. |
| Identified ownership | A form of ownership where the owner's identification is known, preferably |
| | with certainty |
| Identified | A relationship of which at least one of the relationship participants is aware |
| relationships | |
| Identified | A transaction between at least one parties in which the identity of at least |
| transactions | one transaction participant(s) is known to any other participant |
| Identity | The set of distinguishing characteristics that collectively signify a particular |
| | entity |
| Identity masking | A process that provides a false identity for an entity making it anonymous to |
| | another |
| Instant Message | One of the more common communications channels, instant message |
| | systems consists of a collection of several applications and protocols which |
| | are used to control the format and transmission of a message, and |
| | sometimes the contents of and/or attachments to a message. The |
| | applications can be server-based or client-based, with the client-based |
| | applications accessible on numerous types of devices. Additional protocols |
| | can be incorporated in order to extend the types of devices that |
| | send/receive instant messages. Most instant message systems operate in |
| | a real-time or near-real-time fashion, without necessarily storing or |
| | forwarded the messages. |
| Label | A symbol that acts as a published handle for manipulation of an underlying |
| | entity |
| Manipulating | Manipulating and manipulation are used in the broadest possible sense to |
| | refer to “operating upon” an object. For instance, it includes activating, |
| | authenticating, creating, deactivating, destroying, evaluating, generating, |
| | implementing, maintaining, modifying, querying, registering, and/or other |
| | forms operating upon. The object of such manipulation may for example |
| | be data. |
| Open system | A system that allows interaction among potential participants that are not |
| | limited to a defined list |
| Organization | A group of physical persons, a corporation, a legal entity, or a governmental |
| | department or agency that acts on its own behalf at its own discretion |
| Password | A symbol, frequently alphanumeric, that is used to gain secure access to a |
| | device, system, communications network, account or any other object, |
| | service, or activity |
| Person | An individual that acts on its own behalf at its own discretion |
| PIN | A Personal Identification Number, frequently a password consisting of all |
| | numeric digits used to gain secure access to a device, communications |
| | network, account or any other object, service, or activity |
| Privacy | The quality or state of being apart from unauthorized intrusion or |
| | observation |
| Private | Intended for or restricted to the use of a particular person or organization, |
| | not known or intended to be known publicly |
| Public | The quality or state of being exposed to general view |
| Router | A networking device that forwards communications from one |
| | communications network to another |
| Secure | In general, free from danger and from risk of loss or made safe against |
| | adverse contingencies; in a more particular sense, configured to inhibit |
| | unauthorized access |
| Short Message | One of the more common communications channels, short message |
| System (and Short | message systems consists of a collection of several applications and |
| Text Message | protocols which are used to control the format and transmission of a |
| System) | message, and sometimes the contents of and/or attachments to a |
| | message. The applications can be server-based or client-based, with the |
| | client-based applications accessible on numerous types of devices. |
| | Additional protocols can be incorporated in order to extend the types of |
| | devices that send/receive instant messages. Most short message systems |
| | operate in a real-time or near-real-time fashion, without necessarily storing |
| | or forwarded the messages. Short message systems typically contain text- |
| | based messages, but can incorporate some graphic elements, or at least |
| | the ability to display some character combinations as graphics. The user |
| | accessible interface for a short message systems typically is a cellular |
| | phone or pager. |
| Switch | A networking device that can join communications lines together |
| Symbol | At least one letters, numbers, characters, patterns, biometric readings, or |
| | any other thing that indirectly represents another underlying entity whose |
| | distinguishing features are obscured |
| Token | Any symbol, using that term in its broadest possible sense, which is |
| | capable of serving as a unique indicator. In the present invention, such |
| | symbols may for example be letters of any alphabet, punctuation or |
| | inflection symbols, numerals of any type, digital strings, graphic elements, |
| | images of fingerprints (including minutiae), images generated by retinal |
| | scans, voice prints, other sound patterns, electrical pulses, and other things |
| | of whatever form or type that can serve as unique indicators. These may |
| | be used singly or in any combination. |
| Transaction | An activity or request, most frequently an exchange or transfer of goods, |
| | services or funds |
| Transaction history | A record of past activities or requests |

### APPENDIX A: OBJECT IDENTIFICATION NUMBERS

The following table identifies the objects labeled in the included drawings

Travel Information System

| | |
|---|---|
| 1000 | Travel Information System |
| 1100 | Data Source |
| 1110 | Internal Data Source |
| 1120 | External Data Source |
| 1200 | Data |
| 1210 | Feedback |
| 1300 | Processor |
| 1400 | Storage System |
| 1410 | Internal Storage System |
| 1420 | External Storage System |
| 1500 | Distribution Point |
| 1510 | Internal Distribution Point |
| 1520 | External Distribution Point |
| 1530 | Internal Aggregation Point |
| 1540 | External Aggregation Point |
| 1550 | Aggregation Point |
| 1600 | Access Device |
| 1610 | Internal Access Device |
| 1620 | External Access Device |
| 1800 | Feedback Control System |
| 1810 | Exception Handler |
| 1820 | Prediction Engine |
| 1830 | Data Enhancer |

Users

| | |
|---|---|
| 2000 | User |
| 2010 | Internal User |
| 2020 | External User |

Communications Subsystem

Communications Device(s)
External Communications Device(s)
Communications Device Class(es)
Communications Session Management Software
Communications Session
Stateful Communications Session
Stateless Communications Session

Communications Channels

Communications Channel
Communications Channel - Email System
Communications Channel - Web System
Communications Channel - Short Message System
Communications Channel - Instant Message System
Communications Channel - Voicemail System
Communications Channel - Facsimile System
Communications Channel - Peer-to-Peer System
Communications Channel - Other System

Transaction Coordination Subsystem

Transaction Coordination Subsystem

User Interaction Subsystem

User Interaction Subsystem

Encryption Subsystems

Cryptographic Processing Subsystem
ATMS Encryption Engine
Storage Device Encryption Engine
Data Processor Encryption Engine
Communications Device(s) Encryption Engine
Dedicated Encryption Engine
Communications Session Encryption Engine
Communications Channel Encryption Engine

Application Logic Subsystem

Application Logic Subsystem

Account/System Types

Email Account
Web Account
Short Message Account
Instant Message Account
Voicemail Account
Facsimile Account
Peer-to-Peer Account
Other Account

Stimuli; Agents, Alerts, & Triggers

Agents, Alerts, Triggers
External Stimuli
Internal Stimuli

Network Hardware

| | |
|---|---|
| 3410 | Inter-Network Communications Route |
| 3420 | Router |
| 3430 | Concentrator |
| 3440 | Bridge |
| 3450 | Inter-network |

1-67. (canceled)

68. A system, comprising:
a database capable of storing vehicle data;
a processor capable of storing object data in the database;
a manager capable of associating the object data with the vehicle data; and
a map generator capable of displaying a map with at least a subset of the vehicle data and at least a subset of the object data superimposed onto the map.

69. The system of claim 68, wherein the vehicle data includes position, speed and direction of travel of the vehicle.

70. The system of claim 68, wherein the object includes a person.

71. The system of claim 68, wherein the object data is superimposed adjacent to the vehicle data it is associated with.

72. The system of claim 68, wherein the map generator is further capable of redisplaying the map with the superimposed vehicle and object data based on a change in the vehicle or object data.

73. The system of claim 68, wherein the processor is further capable of parsing a travel itinerary into the object data.

74. The system of claim 68, wherein the map generator is further capable of displaying weather on the generated map.

75. The system of claim 68, wherein the manager is further capable of generating an alert when an event occurs that interferes with an estimated arrival time of the vehicle.

76. The system of claim 75, wherein the manager transmits the alert to a device listed in the object data.

77. A method, comprising:
storing object data in a database capable of storing vehicle data;
associating the object data with the vehicle data; and
displaying a map with at least a subset of the vehicle data and at least a subset of the object data superimposed onto the map.

78. The method of claim 77, wherein the vehicle data includes position, speed and direction of travel of the vehicle.

79. The method of claim 77, wherein the object includes a person.

80. The method of claim 77, wherein the object data is superimposed adjacent to the vehicle data it is associated with.

81. The method of claim 77, further comprising redisplaying the map with the superimposed vehicle and object data based on a change in the vehicle or object data.

82. The method of claim 77, further comprising parsing a travel itinerary into the object data.

83. The method of claim 77, further comprising displaying weather on the generated map.

84. The method of claim 77, further comprising generating an alert when an event occurs that interferes with an estimated arrival time of the vehicle.

85. The method of claim 84, further comprising transmitting the alert to a device listed in the object data.

86. A system, comprising:
means for storing object data in a database capable of storing vehicle data;
means for associating the object data with the vehicle data; and
means for displaying a map with at least a subset of the vehicle data and at least a subset of the object data superimposed onto the map.

87. A computer readable medium having stored thereon to cause a computer to execute a method, the method comprising:
storing object data in a database capable of storing vehicle data;
associating the object data with the vehicle data; and
displaying a map with at least a subset of the vehicle data and at least a subset of the object data superimposed onto the map.
